(19) United States
(12) Patent Application Publication
(10) Pub. No.: US 2013/0040649 A1
(43) Pub. Date: Feb. 14, 2013

(54) Mobile Device Location Estimation Using Operational Data of a Wireless Network

(71) Applicants: Leonardo A. Soto Matamala, Los Altos, CA (US); Carlos Alberto Roman Saavedra, Atlanta, GA (US); Richard Jhonson Rossel Quezada, Atlanta, GA (US); Nancy Hickey Watts, Marietta, GA (US)

(72) Inventors: Leonardo A. Soto Matamala, Los Altos, CA (US); Carlos Alberto Roman Saavedra, Atlanta, GA (US); Richard Jhonson Rossel Quezada, Atlanta, GA (US); Nancy Hickey Watts, Marietta, GA (US)

(21) Appl. No.: 13/448,146

(22) Filed: Apr. 16, 2012

Related U.S. Application Data
(60) Provisional application No. 61/475,878, filed on Apr. 15, 2011.

(51) Int. Cl. H04W 24/00; H04W 72/02

(52) U.S. Cl. 455/452.1; 455/456.1

(57) ABSTRACT

A method for location estimation of a mobile device using operational data of a wireless network includes creating a geospatial model of a wireless network. The geospatial model may include a geometry representative of coverage area of each antenna in the wireless network. The geometry may be created, by the modeling module, based on a tower data of the wireless network and an operational data from the wireless network. The geospatial model may further include range bands for each antenna, created based on the operational data. In addition, the method includes generating, by the modeling module, a geospatial model of geospatial features for an area of the wireless network. Further, the method includes determining, by a location module, the location of the mobile device in the wireless network based on the geospatial model of a wireless network, the geospatial model of geospatial features and real-time operational data.

### CROSS REFERENCE TO RELATED APPLICATIONS

This application claims priority to U.S. Provisional Patent Application No. 61/475,878 filed Apr. 15, 2011 in the name of Leonardo A. Soto Matamala and entitled “Mobile Device Location Estimation from Cell Network Signaling Data,” the entire contents of which are hereby incorporated herein by reference.

### FIELD OF INVENTION

This disclosure relates generally to a technical field of location estimation and, in one example embodiment, to a system, method and an apparatus for mobile device location estimation using operational data of a wireless network.

### BACKGROUND

Location based services (LBS) may be an emerging trend in today's digital world. A variety of businesses may use LBS to strategically reach existing and/or potential customers. For example, a restaurant may use location information of a user to offer attractive discounts to a user, when the user is in a vicinity of the restaurant. In another example, location of users commuting on a specific route may be used to determine the meaningful travel information (e.g., speed of traffic, congestion, etc.) on that route, which when provided to a user may save commute time of the user. Example of other contexts that LBS are used may include health, indoor object search, entertainment, work, and/or personal life. LBS may depend on location of a mobile communication device.

Conventional technologies often use global Positioning System (GPS) device to determine positions of mobile communication devises and transmit these data via a wireless network to businesses. While this approach may give accurate information for a small number of devices, any attempt to gather positioning information from a large number of devices may use up large amounts of scarce bandwidth from the wireless network. Further, the said approach may be cost intensive and gathering all the GPS data may be time intensive as well. Further, GPS data may not be available in locations where LBS may be used extensively such as urban cities where high elevation buildings block access to a clear sky.

On the other hand, wireless technologies may have a vast infrastructure of communication facilities that generate data routinely to enable the system to properly function, e.g., to enable cellular phone users to place and receive calls and stay connected to these calls as they move though the cell sectors of a system. Examples of these data include signaling data, call detail records (CDR), handover messages, and/or registration messages. In view of the foregoing, there is a need for a technology for location estimation of mobile communication devices based on data from wireless networks.

### SUMMARY

Disclosed are a method, system and apparatus for mobile device location estimation using operational data of a wireless network. In one aspect, a method includes creating, by a modeling module, sector geometry of an antenna in the wireless network based on a tower data of the wireless network and first operational data from the wireless network. The term sector geometry may generally refer to a geometry and/or data representative of a coverage area of an antenna. The method further includes creating, by the modeling module, a geospatial model of a geospatial feature for an area associated with the wireless network. The method also includes generating, by the modeling module, one or more range bands for the antenna based on the first operational data. Each of the range bands may be bound by a first distance and a second distance from the antenna. Further, the method includes estimating, by a location module, a location of a mobile device in the wireless network. The location may be estimated based on the sector geometry of the antenna, the geospatial model of the geospatial feature, and the one or more range bands of the antenna. The mobile device may be serviced by the antenna.

The term ‘first operational data’ as used herein may generally refer to signaling data collected at a first time. The first operational data may be used to determine the coverage area of an antenna. In some embodiments, the first operational data may be used to estimate the location of the mobile device as well.

In another aspect, a position determination engine may include a modeling module. The modeling module is configured to create, for at least one antenna of one or more antennas in a wireless network, a sector geometry representative of a coverage area of the at least one antenna. The sector geometry may be created based on a tower data of the wireless network and first operational data from the wireless network. The modeling module is also configured to create a geospatial model of a geospatial feature for an area associated with the wireless network. In addition, the modeling module is configured to generate, for the at least one antenna, one or more range bands based on the first operational data. Each of the range bands are bound by a first distance and a second distance. Further, the position determination engine includes a location module configured to estimate a location of a mobile device communicatively associated with an antenna of the one or more antennas in the wireless network. The location may be estimated based on the sector geometry of the antenna, the geospatial model of the geospatial feature, the one or more range bands of the antenna and second operational data.

The term ‘second operational data’ as used herein may generally refer to signaling data collected at a second time. The second operational data may be used to estimate a location of the mobile device. In some embodiments, the second operational data may be used to determine the coverage area of antennas in the network along with determining the location of the mobile device.

In yet another aspect, a system includes a position determination engine. The position determination engine includes a modeling module. The modeling module is configured to create, for each antenna of one or more antennas in the wireless network, a sector geometry representative of a coverage area of each antenna. The sector geometry may be created based on a tower data of the wireless network and historical signaling data from the wireless network. Further, the modeling module is configured to create a geospatial model of a geospatial feature for an area associated with the wireless network. In addition, the modeling module is configured to generate, for each antenna, one or more range bands. Each of the range bands may be bound by a first distance and a second distance that is determined based on the historical signaling data. The system further includes a location module configured to estimate a location of a mobile device in the wireless network. The location may be estimated based on the sector geometry of at least one antenna of the one or more antennas in the wireless network, the geospatial model of the geospatial feature, the one or more range bands of the at least one antenna, and real-time signaling data obtained from the wireless network.

In an additional aspect, a method includes creating, by a modeling module, for each antenna of one or more antennas in the wireless network, a sector geometry re-presentative of a coverage area of each antenna. The sector geometry may be based on a tower data of the wireless network and first operational data from the wireless network. In addition the method includes creating, by the modeling module, a geospatial model of a geospatial feature for an area associated with the wireless network. Further, the method includes generating, by the modeling module, for each antenna, one or more range bands. Each range band may be bound by a first distance and a second distance based on the first operational data. The method also includes estimating, by a location module, a location of a mobile device communicatively associated with an antenna from the one or more antennas in the wireless network. The location may be estimated based on the sector geometry of the antenna, the geospatial model of the geospatial feature, and the one or more range bands of the antenna.

In yet another aspect, a position determination engine includes a modeling module. The modeling module is configured to create, for each antenna of one or more antennas in the wireless network, a sector geometry representative of a coverage area of each antenna. The sector geometry may be created based on a tower data of the wireless network and first operational data from the wireless network. Further, the modeling module is configured to create a geospatial model of a geospatial feature for an area associated with the wireless network. In addition, the position determination engine includes a location module. The location module is configured to estimate a location of a mobile device communicatively associated with an antenna of the one or more antennas in the wireless network. The location is estimated based on the sector geometry of the antenna, the geospatial model of the geospatial feature, and a range band of the antenna.

### BRIEF DESCRIPTION OF THE DRAWINGS

Example embodiments are illustrated by way of example and not limitation in the figures of accompanying drawings, in which:

FIG. 1 illustrates an operating environment for the position determination engine, according to certain exemplary embodiments of the present invention.

FIG. 2 illustrates a block diagram of the position determination engine of FIG. 1, according to certain exemplary embodiments of the present invention.

FIG. 3 illustrates an overview of the position determination engine process, according to certain exemplary embodiments of the present invention.

FIG. 4A illustrates a block diagram of the parser module of the position determination engine, according to certain exemplary embodiments of the present invention.

FIG. 4B illustrates a process of the parser module, according to certain exemplary embodiments of the present invention.

FIG. 5A illustrates a block diagram of the modeling module of the position determination engine, according to certain exemplary embodiments of the present invention.

FIG. 5B illustrates a process of the modeling module for creating geospatial models and associated cellular network sector database, according to certain exemplary embodiments of the present invention.

FIGS. 6A-6C is a graphical representation of the process of generating geospatial model of cellular network coverage, according to certain exemplary embodiments of the present invention.

FIG. 6D presents a graphical representation of overlay of cell sector coverage map database elements, according to certain exemplary embodiments of the present invention.

FIG. 7A illustrates a block diagram of the location module of the position determination engine, according to certain exemplary embodiments of the present invention.

FIG. 7B illustrates a process of the location module for location estimation, according to certain exemplary embodiments of the present invention.

FIGS. 8A-8D (collectively FIG. 8) illustrates a process of determining common region for location estimation of a mobile device based on information from multiple antennas, according to certain exemplary embodiments of the present invention.

FIGS. 9A-9D are graphical representations of the location estimation process using information from one or more antennas, according to certain exemplary embodiments of the present invention.

Many aspects of the invention can be better understood with reference to the above drawings. The elements and features shown in the drawings are not to scale, emphasis instead being placed upon clearly illustrating the principles of exemplary embodiments of the present invention. Moreover, certain dimensions may be exaggerated to help visually convey such principles. In the drawings, reference numerals designate like or corresponding, but not necessarily identical, elements throughout the several views. Other features of the present embodiments will be apparent from the Detailed Description that follows.

### DETAILED DESCRIPTION

Disclosed are a system, a method and an apparatus for mobile device location estimation using operational data of a wireless network It will be appreciated that the various embodiments discussed herein need not necessarily belong to the same group of exemplary embodiments, and may be grouped into various other embodiments not explicitly disclosed herein. In the following description, for purposes of explanation, numerous specific details are set forth in order to provide a thorough understanding of the various embodiments.

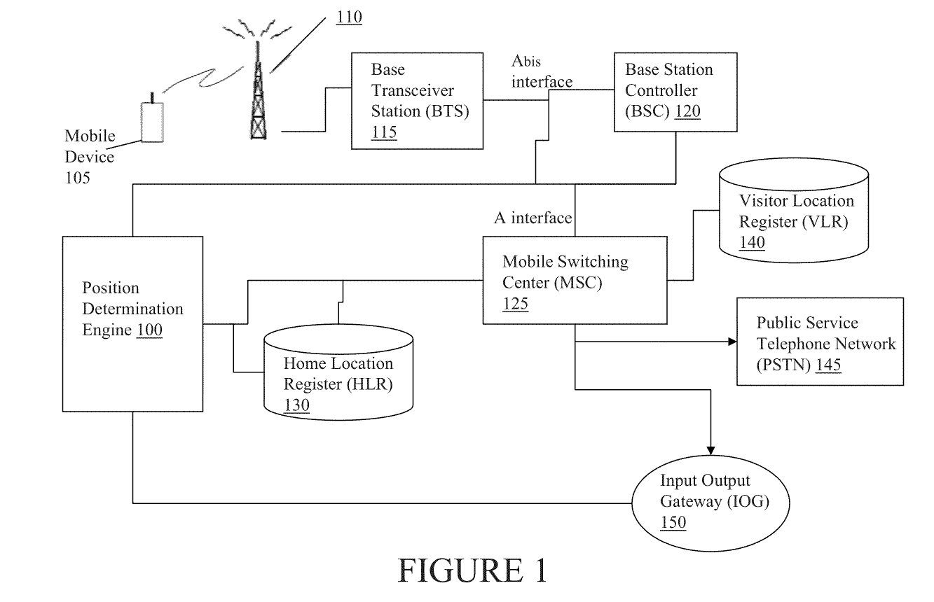

FIG. 1 illustrates an operating environment for the position determination engine, according to certain exemplary embodiments of the present invention. In particular, FIG. 1 illustrates a position determination engine 100, a mobile device 105, cellular tower 110, a base transceiver station 115, a base station controller 120, a mobile switching center 125, a home location register 130, a visitor location register 140, a public service telephone network 145, and an input output gateway 150.

The mobile device (MD) 105 transmits signals to and receives signals from the radiofrequency cellular tower 110 (e.g., transmission tower), while within a geographic cell covered by the cellular tower 110. These cells can vary in size based on anticipated signal volume. The cellular tower 110 may include one or more antennas that facilitate communication within the cell. In one embodiment, the cellular tower 110 may use an omni directional antenna or multiple directional antennas to handle communication within the cell. For example, a cellular tower 110 may have 3 directional antennas that cover 120 degrees each and thereby facilitating communication in 360 degree coverage area. The coverage area of an antenna may be referred to as a sector.

The base transceiver station (BTS) 115 facilitates providing service to mobile subscribers within a cell. Several BTS'S are combined and controlled by the base station controller (BSC) 120 through a connection called the A_{bis} interface. The position determination engine 100 can interface with the A_{bis} interface line as illustrated in FIG. 1. A Mobile Switching Center (MSC) 125 facilitates coordinating multiple BSC's, through the A Interface connection, keeping track of all active mobile subscribers using the Visitor Location Register (VLR) 140, maintaining the home subscriber records using the Home Location Register (HLR) 130, and connecting the mobile subscribers to the Public Service Telephone Network (PSTN) 145. The Input Output Gateway (IOG) 150 processes call detail records (CDRs) to facilitate such actions as mobile subscriber billing. The IOG 150 receives call-related data from the MSC 125 and can interface with the position determination engine 100.

The position determination engine 100 may monitor operational (e.g., signaling) data in the wireless network either directly or using a signal monitoring system such as a protocol analyzer. Alternatively, these messages may be extracted from a Base Station Manager that continuously monitors message streams on the BTS 115.

The term ‘operational data’ as used herein, may generally refer to any appropriate signaling data between an antenna (of a cellular tower) and a mobile device. In one embodiment, during communication, multiple antennas from one or more cellular towers may be communicably visible to and/or may service the mobile device 105. However, at any given time, one antenna of the multiple antennas visible to the mobile device, handles communication (e.g., holds the call) associated with the mobile device, which is referred to as ‘reference antenna’ herein. The other antennas may be referred to as non-reference antennas. For any given reason, if the reference antenna is not able to handle the communication associated with the mobile device, then the communication may be handed over to one of the non-reference antennas. The reference and non-reference antennas associated with the mobile device may be updated based on a location of the mobile device 105.

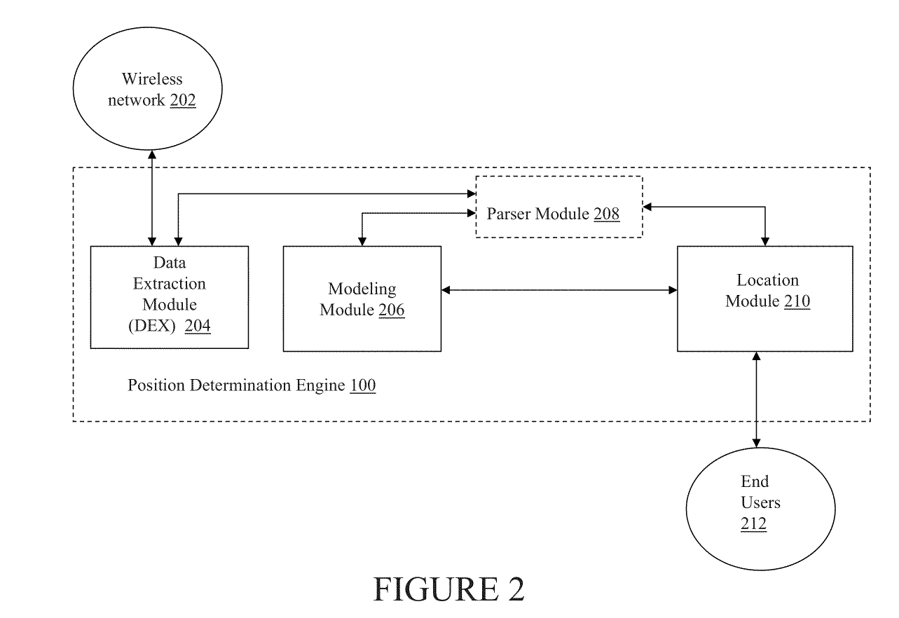

In an exemplary embodiment, the position determination engine 100 may receive operational data from a variety of locations in the wireless network. These locations may include the BSC 120, Abis interface, the BTS 115, MSC 125, and/or the HLR 130. The position determination engine is further described below in association with FIG. 2.

Turning to FIG. 2, FIG. 2 illustrates a block diagram of the position determination engine of FIG. 1, according to certain exemplary embodiments of the present invention. In particular, FIG. 2 illustrates a cellular network 202 otherwise referred to as a wireless network, a data extraction module 204, a modeling module 206, a parser module 208, a location module 210 and end users 212. Even though the term wireless network specifically refers to a cellular network in the following description, one skilled in the art could appreciate and understand that cellular network may be replaced by any appropriate wireless voice and/or data network, such as WLAN, WMAN, or WPAN.

The wireless network 202 can exchange information with the data extraction (DEX) module 204 of the position determination engine 100. Further, the DEX module 204 can exchange information with the parser module 208. The parser module 208 is configured to exchange information with the modeling module 206 and/or the location module 210. The modeling module 206 can exchange information with the location module 210, which in turn can exchange information with end users 212.

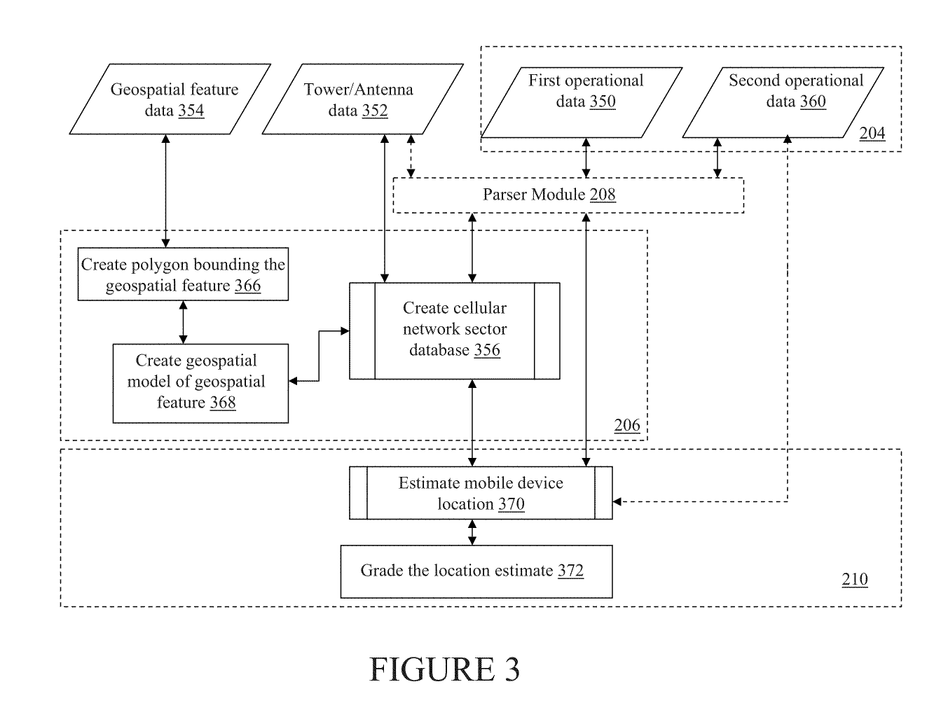

In one embodiment, the DEX module 204 can directly exchange information with the modeling module 206 and/or the end users 212. In one embodiment, the modeling module can exchange information with the end users 212. In some embodiments, a process other than DEX module 204 may provide operational data to the parser module 208, modeling module 206 and/or the location module 210. The end users 212 may include information service providers, location based service providers, a government organization, emergency service providers, transportation providers or media outlets. The type of information exchanged between the modules is described below in association with FIG. 3.

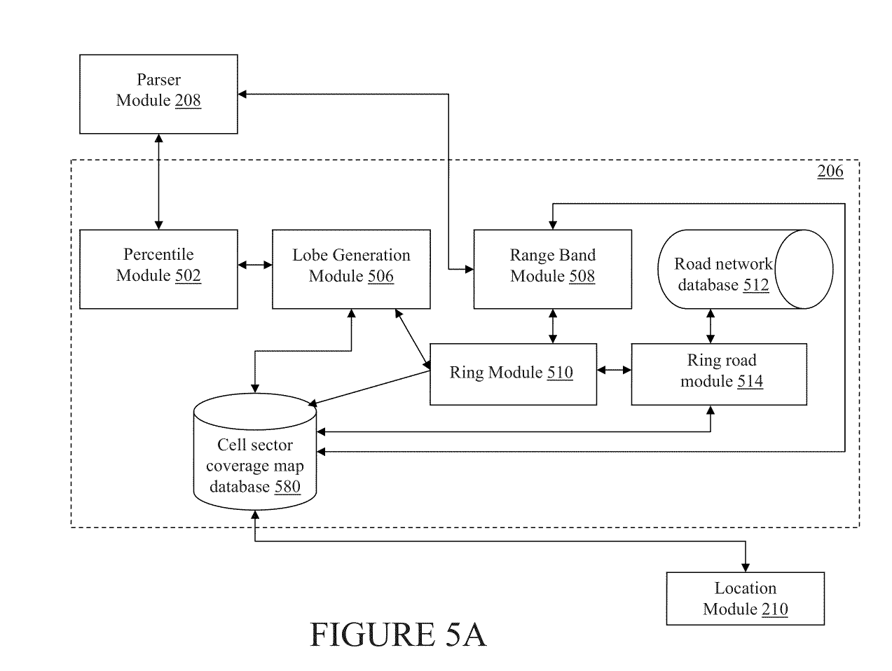

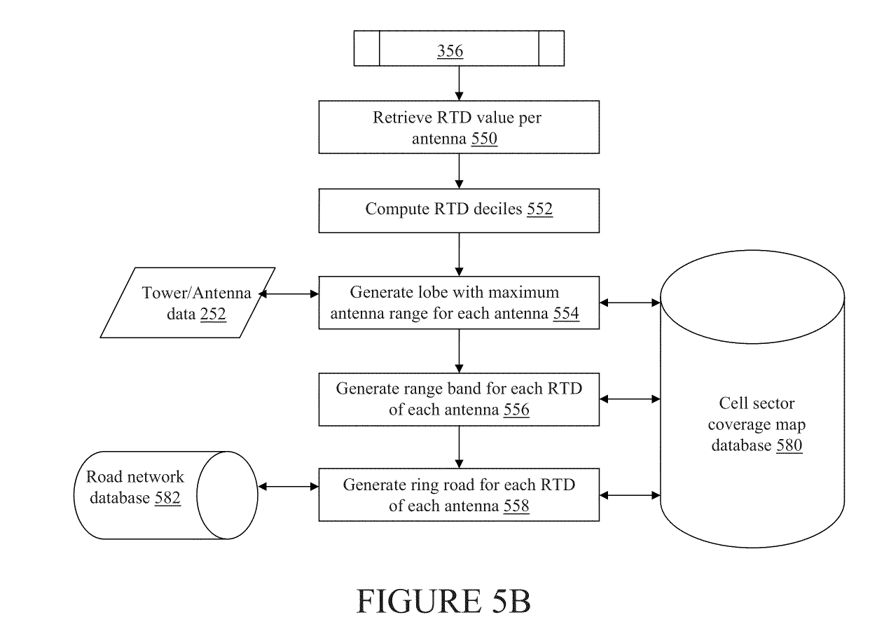

Turning to FIG. 3, FIG. 3 illustrates an overview of the position determination engine process, according to certain exemplary embodiments of the present invention. In operation 366, the modeling module 206 may receive geospatial feature data 354 associated with a region of the wireless network 202. Even though geospatial features are specifically referred to as roads in this description, one of ordinary skill in the art could appreciate and understand that roads may be replaced by lakes, railroads, hallways, pedestrian walkways or any such appropriate feature. The geospatial feature data 354 may be obtained from a government organization, transportation department and/or a commercial vendor. The geospatial feature data 354 may represent the geospatial feature (e.g., road) in the form of lines. In operation 366, the modeling module 206 may create a polygon that bounds the line representing the geospatial feature (e.g., road). The dimension of the polygon that bounds the geospatial feature may be user settable. In an example embodiment, the area bound by the polygon may correspond to a scaled version of the geospatial feature in the real world. In operation 368, the modeling module 206 may receive the polygon geometry representative of the geospatial feature and create a geospatial model of the geospatial feature comprising the representative polygons bounding geospatial features. The geospatial model of the geospatial feature (hereinafter road map) may be stored as road network database (shown in FIG. 5A as 512).

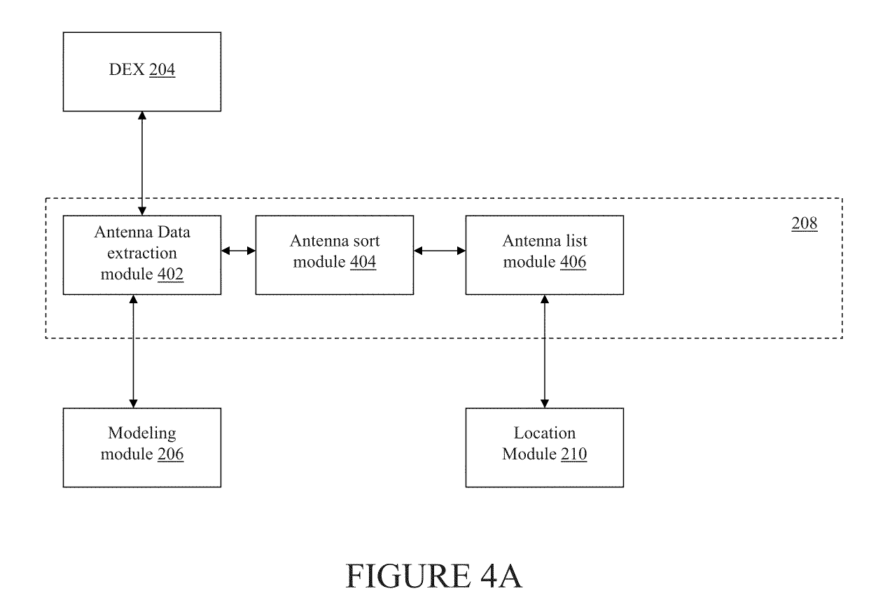

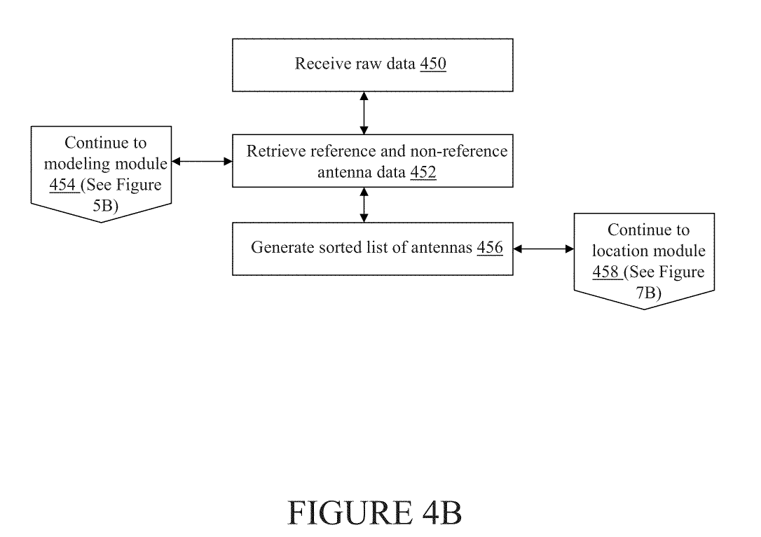

In one embodiment, the parser module 208 may receive the first operational data and/or second operational data from the DEX module 204. In addition, the parser module 208 may process the first operational data and/or the second operational data. Further, the parser module 208 can extract one or more signaling records from the operational data (first and/or second). Typical information contained in a signaling record may include at least the identity of one or multiple cell towers/antennas servicing a call, data indicating the elapsed time that signals take to travel the distance from the antenna to the mobile device (round-trip delay (RTD)), and/or other measures related to distance from the antenna such as a measure of signal phase and/or signal strength. The parser module 208 may parse the signaling record to extract desired data such as the identity of one or multiple cell towers/antennas participating listed in the signaling record call, RTD, signal phase and/or signal strength associated with each antenna. Further, when multiple antennas are communicably visible to the mobile device 105, the parser module 208 can sort the multiple antennas in a specific order. The sorting mechanism may be described in greater detail, in association with FIG. 4B. When multiple antennas are communicably visible to the mobile device 105, this additional information may facilitate determining the most likely sector (coverage area of an antenna) location for the mobile device. Each signaling record of the operational data, (first and/or second) may list information of any antenna that is communicably visible to (and/or services) the mobile device 105.

Further, the signaling record information is time stamped, which allows estimation of the location of the mobile device 105 at a particular point in time. The types and timing of the signaling record from the wireless network 202 may differ by the specific wireless network 202 technology used by the carrier in an area. The types of signaling record that can be received and used in location estimation include call start, completion, or drop, as well as cell tower “handoff” or for some technologies, periodic transactions throughout the call. In one embodiment, signaling records may be generated at the beginning or a call, at the end of a call and/or periodically in between calls based on the wireless network technology. Operational data may be produced for voice calls, text messages, and/or data connections. The operational data can be thought of as a “picture” of one or more cell towers/antennas the mobile device could “see” at the time of the generating or logging the signaling record.

The DEX module 204 interacts with the wireless network 202 to retrieve operational data from the wireless network 202. In one embodiment, the DEX module 204 may be a software module coupled to any appropriate element of the wireless network 202 to retrieve operational data from the wireless network 202. In another embodiment, the DEX module may be a hardware device or a combination of software and hardware device coupled to any appropriate element of the wireless network 202. The DEX module 204 may stream data from the wireless network to the position determination engine 100. The streamed operational data may be stored in the position determination engine 100 or in a storage device external to the position determination engine 100.

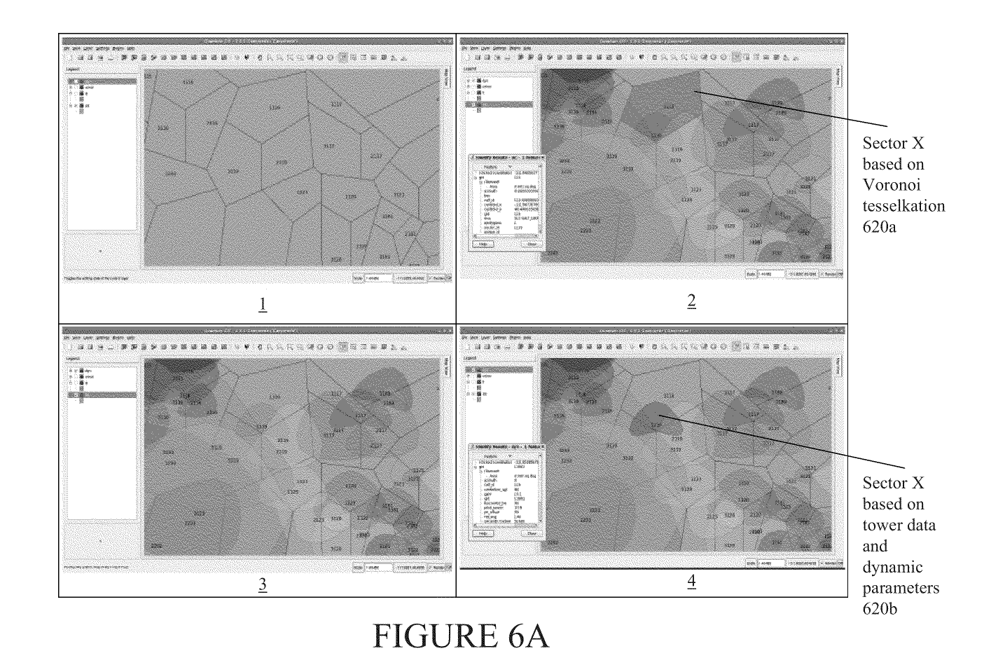

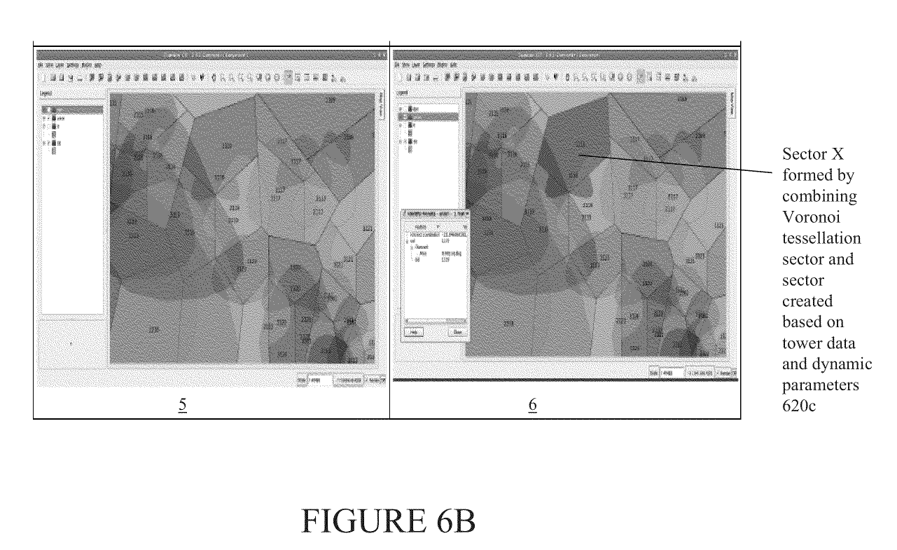

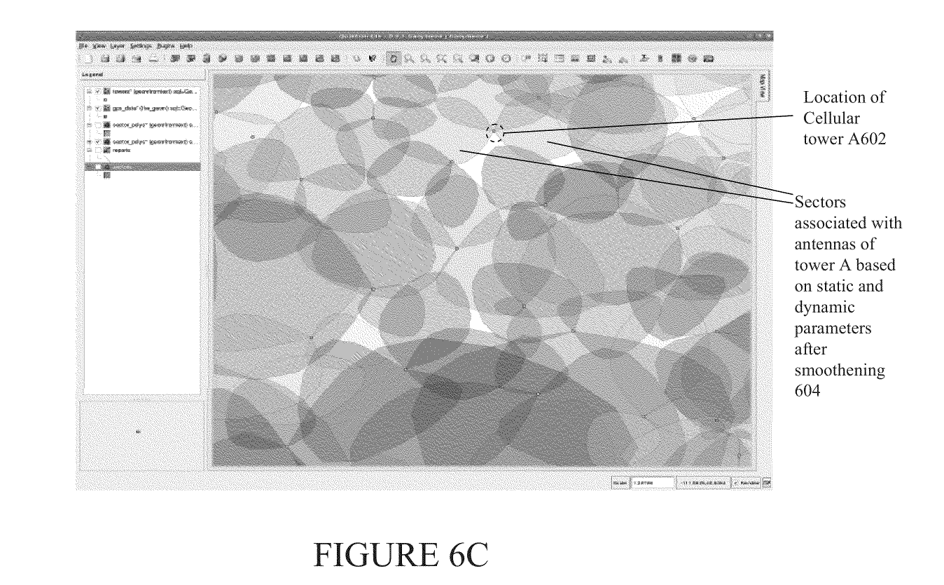

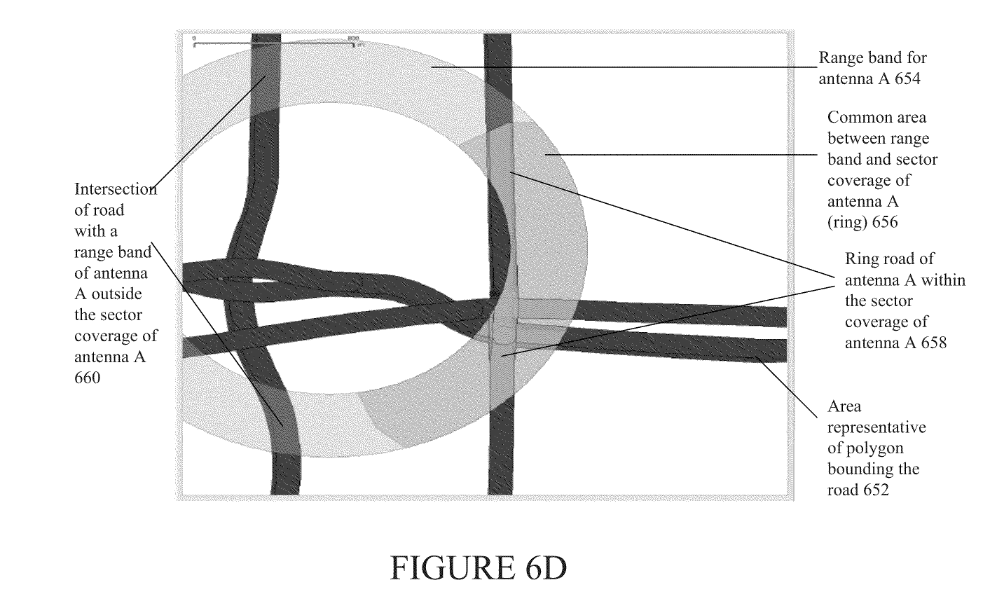

In one embodiment, the first operational data 350 may refer to operational data used to generate various geospatial models that are described in greater detail below and in association with FIGS. 5B-6D. The first operational data may be operational data collected from the wireless network 202 over a predetermined period of time. For example, first operational data used to generate the geospatial models may be collected for a 3-4 hour time interval. Further, the first operational data 350 may be collected during the course of or prior to generating the geospatial models. First operational data 350 may be produced by the wireless network 202 in the normal course of wireless network operation. The first operational data 350 streamed from DEX module 204 may include one or more signaling records.

The second operational data 360 may refer to operational data used to calculate location of the mobile device in the wireless network 202. Once geospatial models are generated using the first operational data, the second operational data may be collected in near real-time during the course of estimating the location of the mobile device 105. In some embodiments, the second operational data 360 may be collected prior to estimating the location of the mobile device 105. In an alternate embodiment, the first operational data 350 may be used to estimate location of the mobile device. Hereinafter, the first operational data may be referred to as historical operational data and the second operational data may be referred to as real-time operational data.

In operation 356, the modeling module 206 may generate a wireless network sector database (cell sector database hereinafter) (shown in FIG. 5A as 580). In one embodiment, the road network database 512 may be a part of the cell sector database 580. The process of creating the cell sector database 580 may include receiving, from the parsing module 208, the parsed data comprising the identity of the antennas, RTD values and/or other appropriate values associated with the antennas in the wireless network 202. In addition, the modeling module 206 may receive tower/antenna data 352 from the wireless network carrier. Tower/Antenna data 352 may be produced and maintained by the carrier and made available to the position determination engine 100. Tower/Antenna data 352 may include the geographic position of the tower (latitude/longitude), a unique identifier for the tower/antenna, the number of antennas on the tower and the specific direction from which they will receive/transmit (the azimuth), as well as a measure of horizontal beam width coverage.

Using the tower/antenna data 352 and the parsed data associated with historical operational data, the modeling module 206 may generate a geospatial model representative of the wireless network coverage. The geospatial model representative of the wireless network coverage may include locations of one or more antennas in the wireless network 202. Further, the geospatial model representative of the wireless network coverage (hereinafter network map) may include geometries defining the coverage areas of each antenna (sectors) of the one or more antenna in the wireless network 202. In one embodiment, calculations of the network map can be performed as often as desired to keep the model updated for changes in the cellular network. For example, the network map may be created every time a carrier adds a tower in the cellular network or when a tower is removed from the cellular network. In an additional embodiment, the calculations of the network map may include changing atmospheric conditions.

Further, in operation 356, the road map created in operation 368 may be stored in the cell sector database and incorporated into (or overlaid on) the network map to create the cell sector database. The process of creating the network map and the cell sector database 580 (in operation 356) is described in greater detail in association with FIGS. 5B-6D. The network map and cell sector data base may be preprocessed. In one embodiment, the network map and the cell sector database may be created as an initial phase of location estimation process. In an alternate embodiment, the network map and/or the cell sector database 580 may be generated and made available to the position determination engine 100 by a commercial vendor or the cellular network carrier.

In operation 370, using the real-time operational data associated with the mobile device 105 and the cell sector data base 580, the location module 210 may estimate the location of the mobile device 105 in the wireless network 202. In another embodiment, the location of the mobile device 105 may be estimated based on the road map, the network map and other features such as range bands associated with the network map. Range bands are described in detail below, in associated with FIG. 5A-5B. In operation 372, the location module 210 may grade an accuracy of the estimated location based on a quality and/or a quantity of elements used to estimate the location. For example, an accuracy of a location estimated based on one antenna may be graded lower than the accuracy of a location estimated using more than one antenna.

The overall process of the position determination engine 100 may be described in greater detail in the following paragraphs, in association with FIGS. 4A-9D.

Turning to FIG. 4A, FIG. 4A illustrates a block diagram of the parser module of the position determination engine, according to certain exemplary embodiments of the present invention. In particular, FIG. 4A illustrates a DEX module 204, an antenna data extraction module 402, an antenna sort module 404, an antenna list module 406, the modeling module 206, and the location module 210.

The DEX module 204 can exchange information with the antenna data extraction module 402. The antenna data extraction module 402 can exchange information with the modeling module 206 and/or the antenna sort module 404. Further, the antenna sort module 404 may exchange information with antenna list module 406, which in turn exchanges information with the location module 210. In some embodiments, the antenna list module 404 may exchange information with the modeling module 206. In an alternate embodiment, operations of the antenna data extraction module 402, the antenna sort module 404 and/or the antenna list module 406 may be performed using any one of the modules. The information exchanged between modules and the operation of the parser module is described in further detail in associated with FIG. 4B.

Turning to FIG. 4B, FIG. 4B illustrates a process of the parser module, according to certain exemplary embodiments of the present invention. In operation 450, the DEX module 204 may stream operational data (historical operational data and/or real-time operational data) to the antenna data extraction module 402 of the parser module 208. In operation 452, the antenna data extraction module 402 can process the operational data to extract signaling records. Further, the antenna data extraction module 402 can parse the signaling records to extract desired antenna data. When the historical operational data is parsed, the extracted data is sent to the modeling module 206 to facilitate creating the cell sector database 580 and/or the network map. In addition, in operation 452, the antenna data extraction module 402 exchanges the operational data (historical and/or real-time) and/or the signaling records with the antenna sort module 404. In operation 456, for each signaling record, the antenna sort module 404 may identify one or more antennas communicably visible to (and/or servicing) the mobile device 105. The antennas may include a reference antenna and one or more non-reference antennas. In operation 456, the antenna sort module 404 may sort the one or more non-reference antennas based on one or more antenna data such as RTD and/or signal strength.

In an exemplary embodiment, the one or more non-reference antennas may be sorted based on RTD values associated with the antennas. Once the non-reference antennas are sorted based on the RTD values and if two or more non-references antennas have substantially similar RTD values, then the first sorted list of non-reference antennas is further sorted based on signal strength values of each non-reference antennas. Based on RTD value, the antennas may be sorted as antennas in the signaling record having lowest RTD value to antennas having highest RTD value, with antenna having lowest RTD value as preferred antenna. Based on signal strength, the antennas may be sorted as antennas in the signaling record having the highest signal strength to antennas having lowest signal strength, with the antenna having highest signal strength as the preferred antenna. In another example embodiment, the non-reference antennas may be sorted based on the signal strength after which they maybe sorted based on the RTD value if required.

Further in operation 456, the sorted non-reference antennas along with the reference antenna are arranged as a list. Further, the list of sorted antennas communicably visible to the mobile device may be forwarded to the location module 210 to facilitate estimating a location of the mobile device. The reference antenna may be the first listed antenna followed by the non-reference antennas in the sorted order.

In one embodiment, the signaling record may include multiple fields. One field of the multiple fields may identify the antenna as a reference antenna. In an alternate embodiment, if the field that identifies the reference antenna is empty, the parser module 208 may sort all the antennas based on signal strength and/or RTD values. The first antenna (antenna with lowest RTD value or highest signal strength) in the sorted list may be identified as reference antenna. In another embodiment, if the field that identifies the reference antenna is empty, the parser module 208 may generate a corresponding error message, which may be transmitted to the end user, location module 210 and/or the modeling module 206. The modeling module 206 is described in greater detail in association with FIGS. 5A-5B.

In another exemplary embodiment, the parser module 208 may process the real-time operational data to extract the associated signaling record. The signaling record may include a number of antennas communicatively associated with (e.g., communicably visible or servicing) a mobile device of the signaling record. The number of antennas may be sorted based on RTD values. In one embodiment, the antenna with the smallest RTD may be set as the reference antenna (regardless of the reference identifier field) and the following antennas may be set as non-reference antenna.

### Model Generation

Turning now to FIG. 5A, FIG. 5A illustrates a block diagram of the modeling module of the position determination engine, according to certain exemplary embodiments of the present invention. In particular, FIG. 5A illustrates a parser module 208, a percentile module 502, a lobe generation module 506, a range band module 508, a ring module 510, a ring road module 514, a geospatial feature module 512 and a location module 210.

The parser module 208 may exchange information with the percentile module, which in turn may exchange information with the lobe generation module 506. Further, the parser module 208 may exchange information with the range band module 508. In an alternate embodiment, the percentile module 502 and/or range band module 508 may directly communicate with the DEX module 206, if the data received from the DEX module is pre-processed to extract desired antenna data.

The lobe generation module 506 and the range band module may exchange information with the ring module 510. Further, the ring module may exchange information with the ring road module 514. The ring road module 514 may be coupled to the road network database 512, with which information may be exchanged. The range band module 508, the lobe generation module 506, the ring module 510 and the ring road module 514 may be logically coupled to the cell sector database 580. In one embodiment, information may be exchanged between the cell sector database 580 and range band module 508, the lobe generation module 506, the ring module 510 and the ring road module 514. The operation of the modeling module and the information exchanged is described in further detail, in association with FIG. 5B.

Turning to FIG. 5B, FIG. 5B illustrates a process of the modeling module for creating geospatial models and associated cellular network sector database, according to certain exemplary embodiments of the present invention. Even though the some of the following description may refer to calculations from the perspective of one antenna in the wireless network, one of ordinary skill in the art could appreciate and understand that the modeling module 206 can handle calculations for numerous antennas in parallel or sequentially.

In operation 550, the percentile module 502 may receive a number of RTD values associated with signaling records of historical operational data collected over a predetermined period of time. In some embodiments, the percentile module 502 may receive other values such as signal strength and/or signal phase.

In one embodiment, the RTD values may be received from the parser module 208. In another embodiment, the RTD values may be directly received from the DEX module 204 provided the DEX module 204 is configured to extract RTD values. In operation 552, the percentile module 502 may process a number of RTD values, associated with an antenna, to generate RTD deciles. In an alternate embodiment, the received RTD values may be distributed into an ‘x’ number of groups. Further, in operation 552, the percentile module 502 may determine a characteristic RTD value based on the RTD deciles. The characteristic RTD value may be determined such that a given percentage of the number of received RTD values of the antenna fall below the characteristic RTD value. For example, the 80^{th} percentile RTD value may be chosen as characteristic RTD such that 80% of the received RTD values fall below the characteristic RTD value.

In operation 554, using the characteristic RTD value and static parameters such as the tower/antenna data 252 (and/or Voronoi generated sectors), the lobe generation module 506 may generate a geometry representative of coverage area of the antenna. The geometry of the antenna coverage area may represent at least a maximum effective range of the antenna that may be calculated based on the characteristic RTD obtained from the historical operational data. The maximum effective range may refer to the maximum distance from the antenna that pilot information from the antenna may be received. Further, the geometry of the antenna coverage area may represent the location of the antenna in the cellular network, the direction of orientation of the antenna and/or the spread of the signal beam associated with the antenna, which may be calculated based on the static tower/antenna data 252. The tower/antenna data 252 may be incorporated with the characteristic RTD (which is a dynamic parameter) to enhance the geometry of the antenna coverage to substantially accurately represent the coverage of the antenna is the real world.

Creating the geometry representative of the antenna coverage area may include creating a “bounding polygon” (typically looking like a kite with the antenna at the bottom of the kite pointed at the top and the “top” point of the kite which may be defined by the maximum calculated effective range of the antenna). In some embodiments, the maximum calculated effective range of the antenna may be determined based on other parameters associated with the historical operational data such as signal phase and/or signal strength. In an alternate embodiment, the maximum calculated effective range of the antenna may be determined based on static parameters. In another embodiment, the maximum effective coverage of the antenna may be provided by the wireless network carrier. The modeling module, may create the sector geometries based on the maximum effective coverage of the antenna sent by the wireless network carrier, the RTD values or a combination of both. Further, the “width” of the polygon (e.g., kite shape) may be determined by the published beam width of the antenna obtained from the tower/antenna data 252 (and/or Voronoi generated sectors). The overall shape may be governed by ratios that were derived to best mimic the off axis attenuation that directional antennas exhibit. Once the bounding polygon is calculated, an appropriate smoothening function may be applied to approximate and smoothen the boundaries of the sector within the bounding polygon. The output of the function may be a lobe-shaped sector approximation that incorporates the dynamic parameter from historical operational data, along with the published identification, location, azimuth, and beam width of the antenna from the tower/antenna data 252. The geometry representative of the antenna coverage area (hereinafter sector geometry) may be stored in the cell sector database 580. The creation of the sector geometry may be graphically presented in FIGS. 6A-6C.

Turning now to FIGS. 6A-6C, FIGS. 6A-6C present a graphical representation of the process of generating geospatial model of cellular network coverage, according to certain exemplary embodiments of the present invention. In particular, FIG. 6A illustrates geometry of Voronoi generated sector (sector X) 620a. Further, FIG. 6A illustrates geometry of the sector X generated by static parameters (e.g., tower data) and dynamic parameters (e.g., RTD, signal strength, signal phase, etc.) 620b.

FIG. 6B illustrates a hybrid approach that generates geometry of sector X 620c by combining the geometry of sector X 620a from Voronoi tessellation and the geometry of sector X 620b from static and dynamic parameters. FIG. 6C illustrates a network map including sector geometries after the sectors are smoothened. In particular, FIG. 6C illustrates the location of a cellular tower A 602 and the sectors geometries 604 associated with the antennas of cellular tower A.

Returning to FIG. 5B, in operation 556, the range band module 508 may receive a number of RTD values from signaling records associated with historical operational data. Each signaling record may include RTD values from one or more antennas in the cellular network. In operation 556, the range band module 508 may convert the RTD value to a corresponding distance. Further, based on the RTD value, the range band module 508 may create a geometry representative of a distance band having a first (e.g., upper bound) distance and a second (e.g., lower bound) distance from the antenna. RTD may be reported as a measure of time (called “chips”) that is set such that one “chip” is equivalent to x meters of distance (e.g., 15 meters of distance). In an exemplary interpretation of RTD, a reading of 100 chips would put the mobile device 1500 meters from the location of the antenna. In the real world, however, this value may not be perfectly accurate, so the range band module may apply mathematical functions that may fit the received RTD value to a historically observed error in the RTD value. These functions may return a first and second distance for the estimated distance (RTD based distance) based on the historically observed error. The resulting region may be a “band” of potential locations around the antenna that comprises the reported distance corresponding to the RTD value including the expected distance error value.

Each antenna may have a number of range bands associated with it, based on the number of RTD values of the antenna. For example, an antenna in the cellular network may have 1000 range bands associated with each antenna. Range band 100 may extend from 1000 meters (e.g., first distance) to 1020 meters (e.g., second distance) which may correspond to RTD values 100 to 120. Thus range band 100 may represent any RTD values that fall between 100 and 120. RTD values that fall outside 100 to 120 value range may fall in another range band associated with the antenna.

Further, in operation 556, the ring module 510 may mathematically or logically intersect (or overlay) each range band of the antenna with the sector geometry of the antenna which may result in a new geometry that represents an area common to the range band and the sector geometry, referred to as a ring. In one embodiment, for each antenna, there may be as many or lesser number of rings as the number of range bands associated with the antenna. The ring may be portion of the range band. In one embodiment, if a range band lies outside the sector geometry, then the range band may not have a ring since the range band does not intersect the sector geometry. The calculated range band values (and/or geometry) and the ring geometries may be stored in the cell sector database 580.

In operation 558, the ring road module 514 may retrieve the road map from the road network database 582. In one embodiment, the road network database 512 may be a part of the cell sector database 580. Further, in operation 558, the ring road module 514 may mathematically or logically intersect the road map with each ring of the antenna. The geometry resulting from the intersection of the road map and the ring, if any, may be stored in the cell sector database 580 as ring roads.

The foregoing operations described in association with FIG. 5B, may refer to calculations for one antenna. To create a network map and/or cell sector database for the cellular network, the said operations may be repeated (sequentially or in parallel) for each tower/antenna in the cellular network.

The cell sector database 580 may refer to a collection of data including data representing sector geometry for each antenna in the cellular network, range band geometry for each antenna in the cellular network, ring geometry of each range band for each antenna in the cellular network, ring road geometry of each ring for each antenna in the cellular network and/or the road map. Using an appropriate API, the data of the cell sector database may be visually represented (e.g., as a map) as illustrated in FIG. 6D.

Turning to FIG. 6D, FIG. 6D presents a graphical representation of overlay of cell sector coverage map database elements, according to certain exemplary embodiments of the present invention. FIG. 6D illustrates cell sector database elements associated with an example antenna A. Antenna A may have a number of range bands and one of the range band 654 is illustrated in the exemplary embodiment of FIG. 6D. Further, the exemplary embodiment of FIG. 6D illustrates the ring 656 representative of an area of intersection between the range band 654 and the sector geometry of antenna A (not shown in the Figure). The area of intersection between the ring 656 and the road map 652 is represented as ring road 658. FIG. 6D also illustrates an area of intersection 660 of the road map with the range band 654 outside the ring 656.

In one embodiment, the cell sector database 580 may be preprocessed prior to estimating the location of a mobile device in the wireless network 202. In another embodiment, the cell sector database 580 may be created as an initial phase of the location estimation process. Using the data in the cell sector database 580, the location module 210 may estimate the location of a mobile device 105 in the wireless network 202 based on real-time operational data. In one embodiment, the real-time operational data may be streamed by the DEX module 204 once the cell sector database 580 is created.

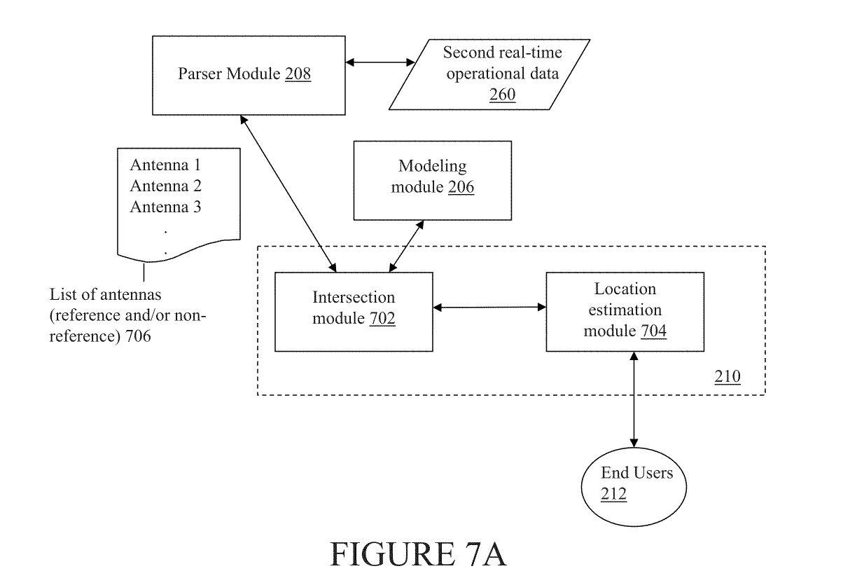

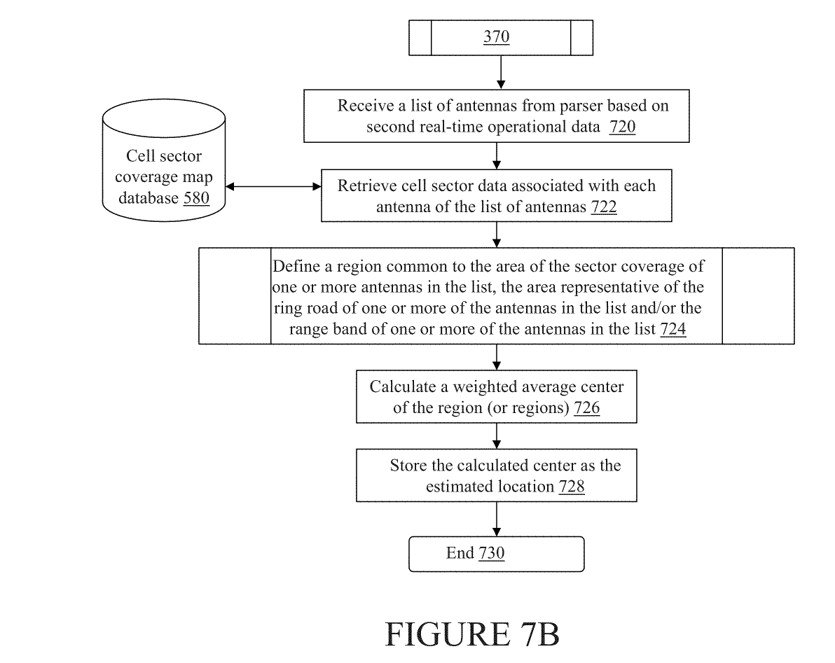

In one embodiment, the cell sector database may refer to a collection of data including data representative of the sector geometry for each antenna in the cellular network and road map. In the said embodiment, the ring geometry of each range band for each antenna in the cellular network and ring road geometry of each ring for each antenna in the cellular network may be created by the location module 210. The location estimation module 210 may be described in greater detail in association with FIG. 7A.

### Location Estimation

In one embodiment, a location of a mobile device 105 in the wireless network 202 may be estimated, by the location module 210, based on real-time operational data received (e.g., streamed by DEX module 204) from the cellular network. The real-time operational data may include a number of signal records. Each signal record may be associated with the communication of a mobile device in the cellular network and the one or more antennas assisting the communication.

In one embodiment, the location of the mobile device 105 may be estimated for each signaling record. In another embodiment, the location of the mobile device 105 may be estimated upon request. All the estimated locations for the mobile device 105 may be stored in a location database and the location may be retrieved by an end user 212 through accessing the database. Alternately, the location may be presented to the end user 212 by the position determination engine 100 upon request.

Turning to FIG. 7A, FIG. 7A illustrates a block diagram of the location module of the position determination engine, according to certain exemplary embodiments of the present invention. In particular, FIG. 7A illustrates the parser module 208, the real-time operational data otherwise referred to as second operational data 260, a list of antenna document 706, the modeling module 206, an intersection module 702, a location estimation module 704 and the end users 212.

The parser module 204 may exchange information with the DEX module 204. In addition, the parser module 208 may exchange information (e.g., list of antennas 706) with the intersection module 702. In an alternate embodiment, the intersection module 702 may receive real-time operational data directly from the DEX module 204. Further, the modeling module 206 may exchange information with the intersection module 702, which in turn exchanges information with the location estimation module 704. The location estimation module 704 may exchange information with end users 212. The operation of the location module 210 and the information exchanged between the modules is discussed in greater detail in association with FIG. 7B.

Turning to FIG. 7B, FIG. 7B illustrates a process of the location module for location estimation, according to certain exemplary embodiments of the present invention. As described in FIG. 4B, the parser module 208 may receive real-time operational data from the DEX module 204, which may include a number of signaling records. For each signaling record, the parser module 208 may identify a number of antennas serving (or communicably visible to) the mobile device 105. Further, the parser module 208 may generate a list 706 including the antennas serving the mobile device 105. In one embodiment, the list 706 may include a reference antenna. In another embodiment, the list 706 may include the reference antenna and one non-reference antenna. In some embodiments, the list 706 may include the reference antenna and a number of non-reference antennas. The non-references antennas may be sorted based on RTD values and/or signal strength values as described in FIG. 4B.

Further, for each signaling data the parser module 208 may retrieve information associated with each antenna in the list 706. The information associated with the antenna extracted from the signaling record may include at least a market identifier, a cell/tower identifier, a sector/antenna identifier, a round trip delay and/or signal strength.

In operation 720, the intersection module 702 may receive the list of antennas 706 and/or the information associated with the each antenna in the list 706. Using the received list of antennas 706 and information associated with each antenna, in operation 722, the intersection module 702 may access the cell sector database to retrieve appropriate data from the cell sector database for each antenna in the list 706. The data from the cell sector database 580 may be used to estimate the location of the mobile device 105. The process of retrieving appropriate data from the cell sector database based on the real-time operational data is described in the following paragraph, using an example.

In the example, a cell sector database 580 may include data representative of the sector geometries of antenna A, B and C in the wireless network 202. The antennas may belong to one tower 110 or different towers in the wireless network 202. Further, the cell sector database 580 may include data representative of range bands associated with each antenna, ring geometry for each range band and ring road geometries. In the example embodiment, the DEX module 204 may stream real-time operational data from the wireless network 202 to the position determination engine 100. The real-time operational module may include a signaling record X associated with mobile device 105. The parser module 204 may process the signaling record X to generate a list of antennas communicably visible to (and/or serving) the mobile device 105 and information associated with each antenna in the list. In the example embodiment, the information from signaling record X may identify antenna A and antenna C as the serving antennas. Further, the list may identify antenna A as the reference antenna and antenna C as the non-reference antenna. The information associated with each of the antennas may include, RTD value associated with antenna A (e.g., 100) and RTD value associated with antenna C (e.g., 60). Once the RTD values are determined, the intersection module 702 may access the cell sector database 580 to retrieve sector geometry associated with antenna A and antenna C. Further, the intersection module 702 may retrieve the range band associated with antenna A which contains the RTD value 100 (corresponding distance value) (e.g., range band 10) and the range band associated with antenna C which contains the RTD value 60 (corresponding distance value) (e.g., range band 6). In addition, the rings and ring roads associated with range band 10 and range band 6 may be retrieved as well.

Once the appropriate data from the cell sector database is retrieved, in operation 724 the intersection module 702 may determine an overlapping region (e.g., common region, region of intersection, etc.) between the areas representative of the geometries retrieved from the cell sector database 580.

When the list includes one antenna, then the intersection module 702 may set the common region (or intersection region) as either the ring geometry and/or ring road geometry associated with the antenna. However, if the list includes more than one antenna, then the intersection module 702 may determine the common region by finding an intersection between one or more elements (e.g., rings, ring roads, sector geometry, etc.) of all the listed antennas.

The number of antennas in the list 706 may determine the number of constraints used to estimate the location of the mobile device 105. In some embodiments, the constraints may be relaxed to obtain a common region. The process of determining a common region when the list 706 includes a single antenna and/or multiple antennas may be described in greater detail in the following paragraphs.

### Estimating Region of Intersection

Case 1: When the list of antennas 706 includes a reference antenna and no non-reference antennas.

The process of the intersection module 702 may include:
1) Processing the signaling record obtained from the real-time operational data to extract an antenna identifier of the reference antenna (ref_id). The signaling record may be associated with the mobile device.
2) Extracting an RTD (RTD_ref) value of the reference antenna from the signaling record associated with the mobile device.
3) Identifying a range band (range_ref) of the reference antenna (ref_id) comprising the RTD_ref value.
4) Retrieving the ring geometry (or data) and/or ring road geometry (or data) associated with range_ref.

The intersection module 702 may retrieve the ring geometry and the ring road geometry using an appropriate function. In one embodiment, the function may return a value for the ring and/or ring road. In another embodiment, the function may return an empty value for the ring road. An empty ring road value may indicate that there are no roads intersecting the ring. In some embodiments, the function may return an empty value for the ring geometry. In one embodiment, an empty ring value may indicate that the range band corresponding to RTD value (RTD_ref) may be outside the sector geometry of the antenna and therefore does not intersect the sector geometry of the reference antenna. In another embodiment, an empty ring value may indicate that a range band comprising the RTD_ref value does not exist in the cell sector database 580. In an additional embodiment, the function may return multiple values for the ring road which may indicate that the ring geometry intersects and the road (or multiple roads) intersects at multiple locations within the ring (multiple disjoint ring roads for a given ring).

On the basis of the intersections, the intersection module 702 may determine the common region (region of intersection). In one embodiment, the common region may be identified as the ring road, if any. If there is no ring road, then the ring may be identified as the common region. If, both the ring and ring road does not exist then sector geometry of the reference antenna may be identified as the common region.

In another embodiment, the cell sector database may include the sector geometry of the antennas in the wireless network 202 and the road map. The range bands, ring geometry and the ring road geometry may be created by the location module 210 as a part of the location estimation process. The location module 210 may create the range band based on RTD value of the antenna (in the list 706) received from the parser module 208. Using the sector geometry of the antenna from the cell sector database 580, the road map from the cell sector database 580 and the created range band, the location module may determine a common region.

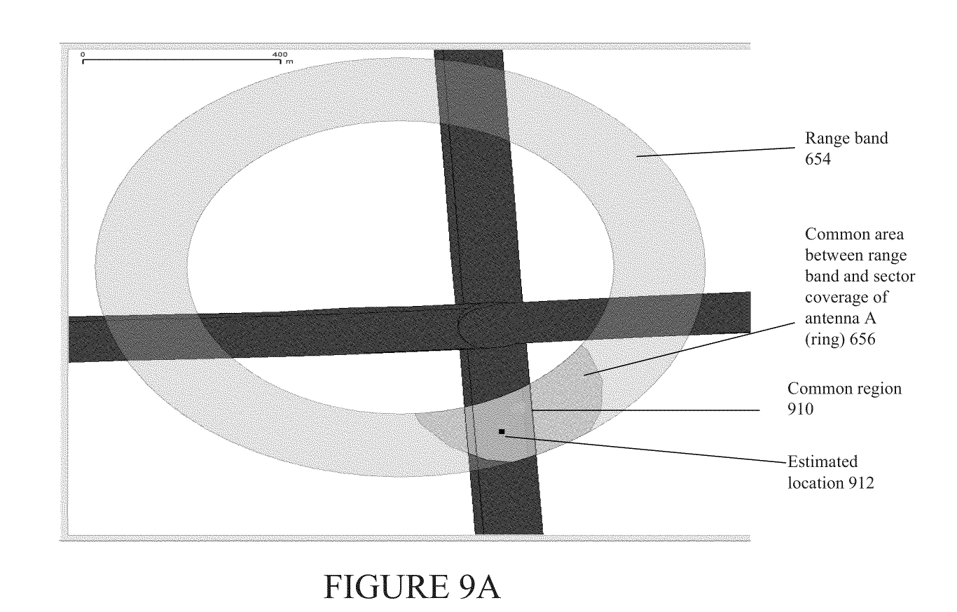

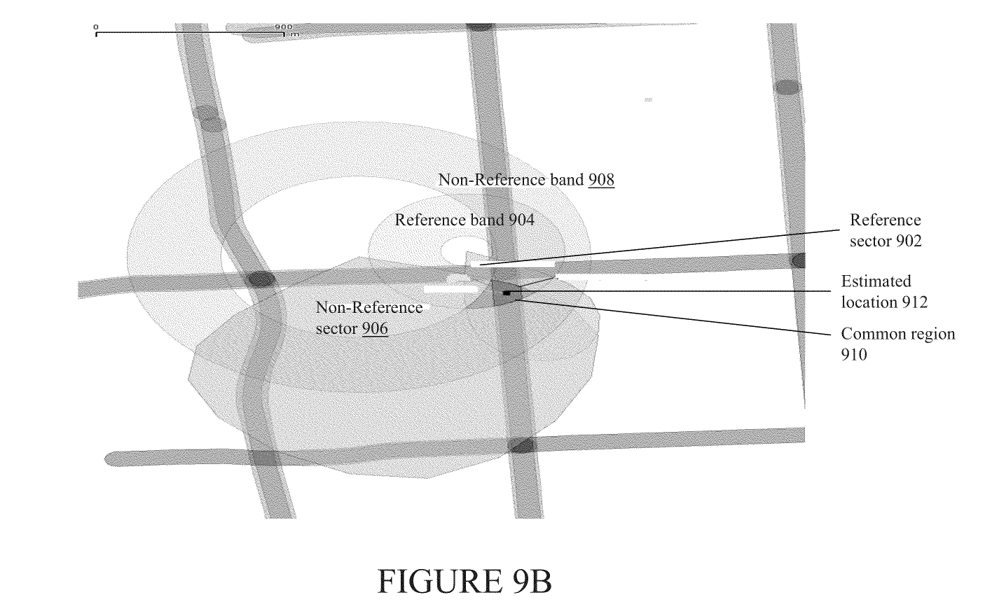

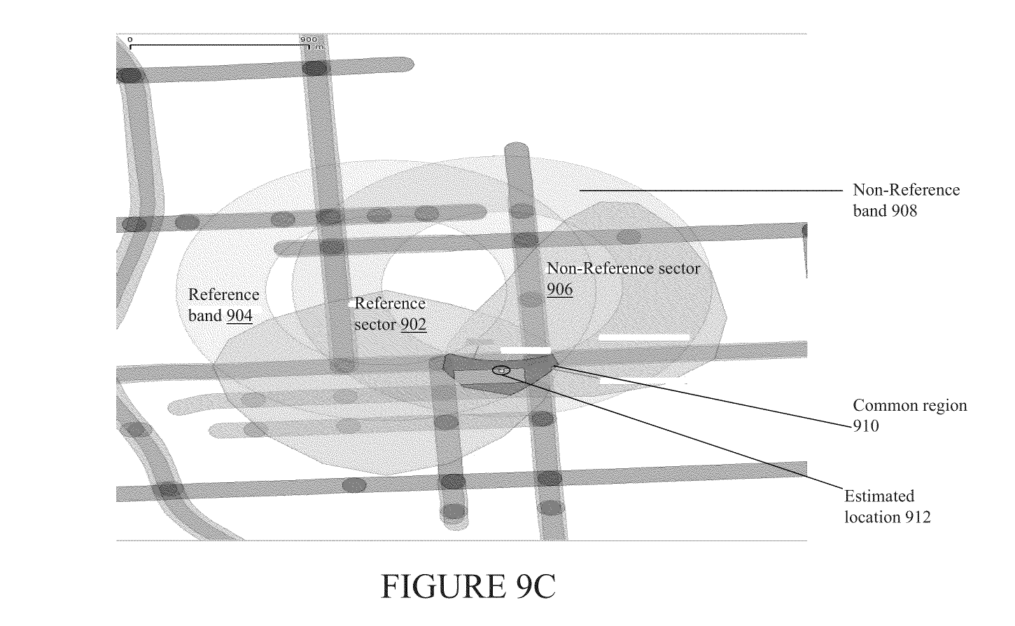

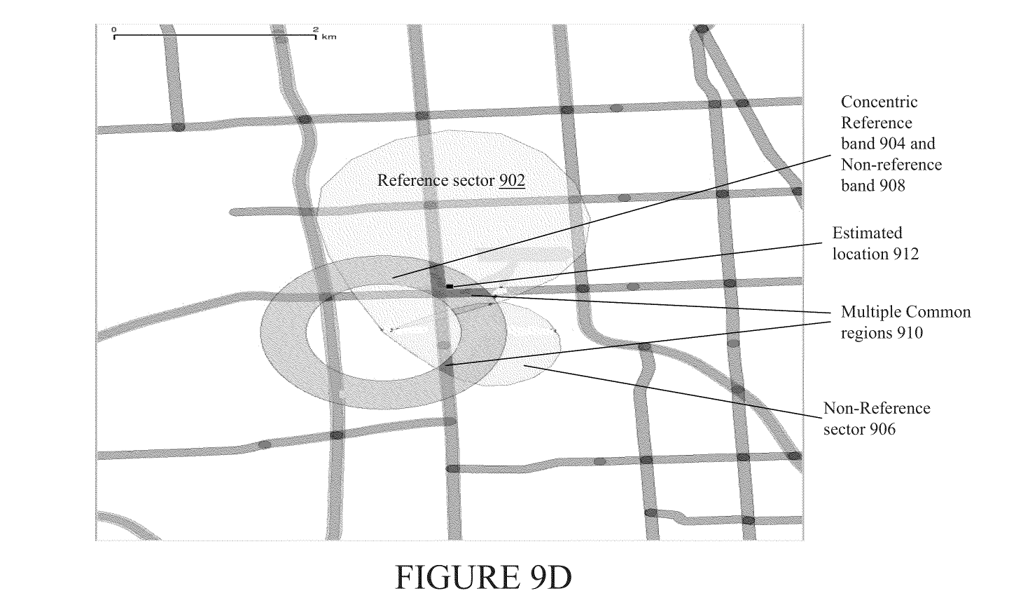

The process of estimating a common region and estimating a location therefrom for one antenna is illustrated in greater detail in FIG. 9A. FIG. 9A is a graphical representation of the location estimation process using information from one antenna, according to certain exemplary embodiments of the present invention. In particular, FIG. 9A illustrates the range band 654, the ring 656, the common region 910 and the estimated location 912. The process of estimating the location from the common region may be described in the following paragraphs, in association with FIG. 7B.

Returning to FIG. 7B,

Case 2: When the list of antennas 706 include a reference antenna and a non-reference antenna.

The process of the intersection module 702 may include:
1) Processing the signaling record obtained from the real-time operational data to extract the antenna identifier of the reference antenna (ref_id) and non-reference antenna (non-ref_id). The signaling record may be associated with the mobile device.
2) Extracting the RTD value of the reference antenna (RTD_ref) and the RTD value of the non-reference antenna (RTD_non-ref) from the signaling record associated with the mobile device.
3) Identifying the range band (range_ref) comprising the RTD_ref value for the sector geometry corresponding to ref_id and the range band (range_non-ref) comprising the RTD_non-ref value for the sector geometry corresponding to non-ref_id.
4) Retrieving the ring geometry (data) and/or ring road geometry (data) associated with range_ref and range_non-ref.

In this case, the common region(s) may be defined as the geometry in which all the constraints are met. The constraints may include sector geometry of reference antenna (ref_id), sector geometry of non-reference antenna (non-ref_id), range_ref, range_non-ref, ring geometry of range_ref, ring geometry of range_non-ref, ring road geometry of range_ref and ring road geometry of range_non-ref. In an example embodiment, the common region(s) may be determined based on either one of the following equations that use AND operators:

Common region=(Ring Road_{reference} AND Ring Road_{non-reference}) (1)

Or

Common region=(Ring_{reference} AND Ring_{non-reference}) AND (Sector_{ref}_{_{—}}_{id} AND Sector_{non-ref}_{_{—}}_{id}) AND Road map (2)

Equation 1 and Equation 2 may identify the common region(s) as a geometry obtained when all the constraints intersect. In other words, according to Equations 1 and 2, the mobile device 105 may be present in a region where the ring roads of the reference sector and the non-reference sector intersect or the mobile device may be present in the non-reference sector, the reference sector, the reference ring, the non-reference ring and the road map.

If the common region determined by Equations 1 or 2 returns an empty set i.e., an intersection between all the constraints do not exist, then the conditions applied on the constraints may be relaxed. In an example embodiment, the condition on the constraints may be changed such that the mobile device may be located in either the sector geometry of the reference antenna OR the sector geometry of the non-reference antenna instead of using an AND operation. In an example embodiment, the common region(s) may be determined based on the following equation that uses an OR operator:

Common region=(Ring_{reference} AND Ring_{non-reference}) AND (Sector_{ref}_{_{—}}_{id} OR Sector_{non-ref}_{_{—}}_{id}) AND Road map (3)

If Equation 3 returns an empty value as well, the conditions on the constraints are further relaxed till at least one common region is determined. In no common region is identified, the sector geometry of the reference antenna may be defined as the common region.

In another embodiment, the cell sector database may include the sector geometry of the antennas in the wireless network 202 and the road map. The range bands, ring geometry and the ring road geometry may be created by the location module 210 as a part of the location estimation process. The location module 210 may create the range band of the reference antenna and the non-reference antenna based on the RTD value of the reference antenna and the non-reference antenna respectively (in the list 706). Using the sector geometry of the reference and the non-reference antenna from the cell sector database 580, the road map from the cell sector database 580 and the created range bands, the location module may determine a common region based on Equations 2 or 3. The process of estimating a common region and estimating a location therefrom is illustrated in greater detail in FIGS. 9B-9D.

FIG. 9B is a graphical representation of the location estimation process using information from a reference antenna and a non-reference antenna, according to certain exemplary embodiments of the present invention. In this example illustration all the constraints are met, i.e., the intersection is not empty when intersecting the reference and non-reference sectors 902 and 906, the reference and non-reference range bands 904 and 908, and the road map covered by those sectors 906 and 902. On the basis of the intersection, the common region may be determined as the geometry of region 910. Further, the location is estimated as location 912.

FIG. 9C is a graphical representation of the location estimation process using information from a reference antenna and a non-reference antenna having multiple intersection areas, according to certain exemplary embodiments of the present invention. In particular, FIG. 9C illustrates the non-reference sector 906, the reference sector 902, the non-reference range band 908, the reference band 904, the common region 910 and the estimated location 912. In FIG. 9C, the range bands 904 and 908 of the reference antenna and the non-reference antenna intersect at two different areas. In this case, one of the areas (of the range band intersection) may be eliminated based on the sector geometries of the antennas (e.g., 902 and 906). The elimination is made such the area intersecting with the sector geometries of the reference antenna and/or non-reference antenna is considered as common region.

FIG. 9D is a graphical representation of the location estimation process using information from a reference antenna and a non-reference antenna having concentric range bands, according to certain exemplary embodiments of the present invention. This case is an example of relaxing the “simultaneously on both range bands” constraint, because the area of intersection of range bands and the sector geometries do not overlap with a road segment, thereby resulting in an empty intersection. So the constraints may be relaxed. In order to relax the constraints the intersection module 702 may change the constraint condition to intersection “over at least one of the sectors”. In FIG. 9D; both the reference antenna and the non-reference antenna have ring roads. However, the ring road of the reference antenna is chosen in this case. The common region is reduced to the geometry represented by region 910.

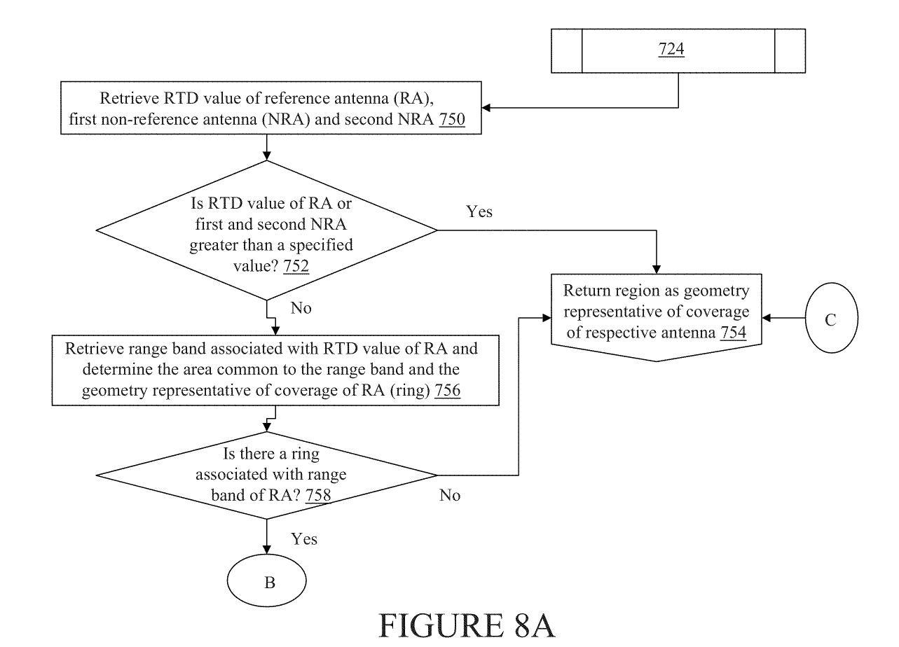

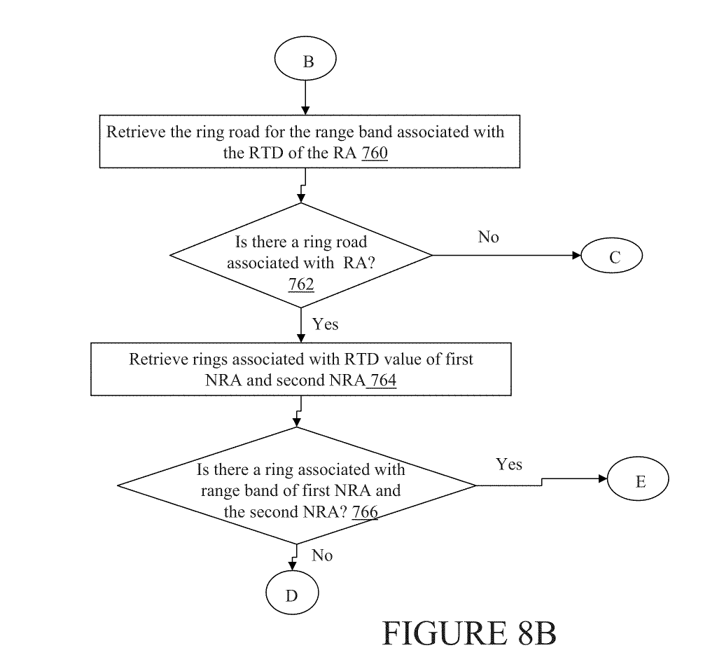

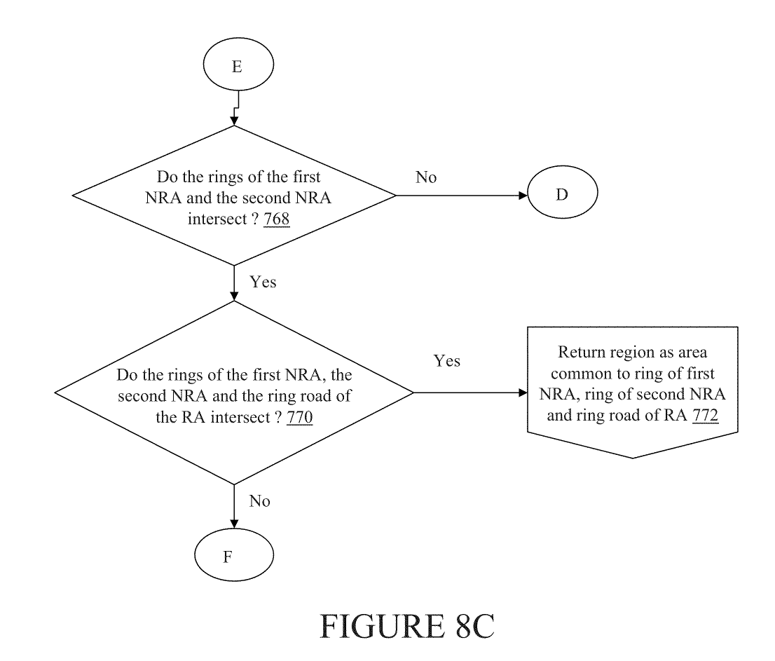

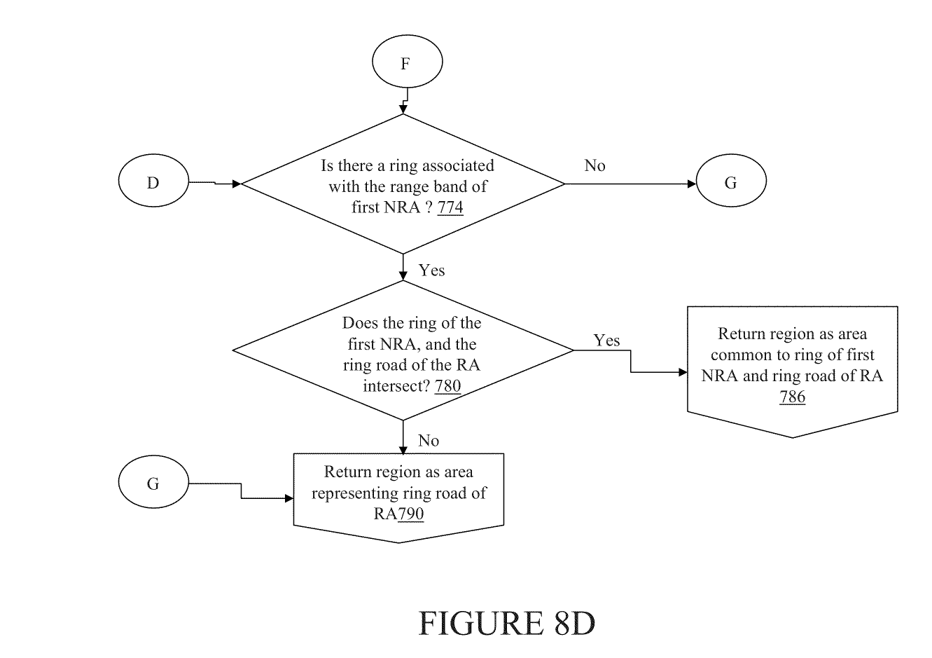

Turning now to FIGS. 8A-8D (collectively FIG. 8), FIG. 8 illustrates a process of determining common region for location estimation of a mobile device based on information from multiple antennas, according to certain exemplary embodiments of the present invention. In particular, FIG. 8 illustrates location estimation when the list of antennas 706 (representing antennas that service the mobile device at a given time) includes one reference antenna and two non-reference antennas.

In operation 750, the intersection module 702 may retrieve the RTD value of the reference antenna, the RTD value of the first non-reference antenna and the RTD value of the second non-reference antenna in the list 706. In one embodiment, the parser module 208 may provide the RTD value for each antenna in the list 706. In an alternate embodiment, the intersection module 702 may process the signaling record to extract the corresponding RTD values associated with each antenna in the list 706.

In operation 752, the intersection module 702 may determine whether the RTD value of either one of the antennas in the list 706 is greater than a specified value. If the RTD value is greater than the specified value, the intersection module 702 may proceed to operation 754, where the intersection module 702 may define the sector geometry of the reference antenna as the common region. In operation 752, if it is determined that the RTD value is below the specified value, the intersection module 702 may proceed to operation 756. In operation 756, the intersection module 702 may access the cell sector database 580 to retrieve the range band geometry that includes the distance value corresponding to the RTD value of the reference antenna. In addition, the intersection module 702 may make appropriate function calls to retrieve the ring geometry associated with the range band geometry of the reference antenna.

In operation 758, if the function call for the ring geometry returns an empty value, the intersection module 702 may proceed to operation 754, in which the sector geometry of the reference antenna is defined as the common region. If the function call for the ring geometry returns a value, then the intersection module 702 proceeds to operation 760. In operation 760, the intersection module 702 may issue a function call to retrieve ring road geometry for the ring geometry of the reference antenna. In operation 762, if the function call for the ring road geometry returns an empty value, the intersection module 702 may define the sector geometry of the reference antenna as the common region (in operation 754). However, if the function call for the ring road returns a value, the intersection module 702 may proceed to operation 764.

In operation 764, the intersection module 702 may issue a function call to retrieve both the ring geometries associated with the first non-reference antenna and the second non-reference antenna. Based on the value of the function call, the intersection module 702 may proceed to either operation 774 or operation 768. If the function call for ring geometries of the first non-reference antenna (associated with RTD value of first non-reference antenna) and the second non-reference antenna ((associated with RTD value of first non-reference antenna) returns a value, then the intersection module proceeds to operation 768. In operation 768, the intersection module 702 checks if the ring geometries of the first non-reference antenna and the second non-reference antenna intersect. If they intersect, the intersection module 702 may proceed to operation 770, where an additional constraint is added. The additional constraint may be the ring road of the reference antenna. In operation 770, the intersection module 702 checks if the ring geometry of the first non-reference antenna, ring geometry of the second non-reference antenna and the ring road geometry of the reference antenna intersect with each other. If the ring geometries of the first non-reference antenna and the second non-reference antenna and the ring road geometry of the reference antenna intersect, intersection module 702 may proceed to operation 772. In operation 772, the intersection module 702 may define the geometry (or region) representative of the area of intersection of the he first non-reference antenna and the second non-reference antenna intersect and the ring road geometry of the reference antenna, as the common region.

If the ring geometries of the first non-reference antenna and the second non-reference antenna and the ring road geometry of the reference antenna do not intersect, the intersection module 702 may proceed to operation 774. Returning to operation 766, if the function call for ring geometries of the first non-reference antenna and the second non-reference antenna returns an empty value, the intersection module 702 may proceed to operation 774. In operation 774, the intersection module 702 may check if the cell sector database contains the ring geometry of the first non-reference antenna. If the cell sector database 580 contains the ring geometry of the first non-reference antenna, then the location module may retrieve the ring geometry of the first non-reference antenna and proceed to operation 780. In operation 780, the intersection module 702 checks if the ring geometry of the first non-reference antenna intersects the ring road geometry of the reference antenna. If the ring geometry of the first non-reference antenna intersects the ring road geometry of the reference antenna, in operation 786 the intersection module 702 may define the geometry representative of the area of intersection between the ring geometry of the first non-reference antenna and the ring road geometry of the reference antenna as the common region.

If either the cell sector database does not contain the ring geometry of the first non-reference antenna or the ring geometry of the first non-reference antenna does not intersects the ring road geometry of the reference antenna, the intersection module 702 may define the ring road geometry of the reference antenna as the common region.

Briefly, the intersection module 702 may check whether the reference antenna has a ring road associated with the RTD value of the reference antenna. If there is a ring road, the intersection module 702 may check if the non-reference antennas have ring geometries associated with their respective RTD values and then tries to find an intersection between the ring roads of the reference antenna and the rings of the non-reference antennas. If such an intersection does not exist, then the intersection module 702 may relax the constraint, by trying to find an intersection between the ring road of the reference antenna and the ring geometry of the first non-reference antenna. If such an intersection does not exist for the relaxed constraint, then the ring road of the reference antenna may be set as the common region. However, if any of the said intersections do exist, then the intersection module 702 defines the geometry representative of the area of intersection as the common region.

Further, if the ring road geometry for the reference antenna does not exist, the sector geometry of the reference antenna is set as the common region. The intersection module 702 may return the common region to the location estimation module 704.

Returning to FIG. 7B, in operation 726 the location estimation module 704 may receive the common region 910 (or respective data) from the intersection module 702 and calculate a weighted average center 912 of the one or more common regions. Further, in operation 728, the calculated center may be set as the estimated location and stored in a location database. The end users 212 may access the location using an API. The process ends at operation 730. In one embodiment, the operations of FIG. 7B may be repeated for each signaling record of the real-time operational data, to determine locations of each mobile station associated with each signaling record.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

The terms “invention,” “the invention,” “this invention,” and “the present invention,” as used herein, intend to refer broadly to all disclosed subject matter and teaching, and recitations containing these terms should not be misconstrued as limiting the subject matter taught herein or to limit the meaning or scope of the claims. From the description of the exemplary embodiments, equivalents of the elements shown therein will suggest themselves to those skilled in the art, and ways of constructing other embodiments of the present invention will appear to practitioners of the art. Therefore, the scope of the present invention is to be limited only by the claims that follow.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A computer program product tangibly embodied in a non-transitory storage medium and comprising instructions that when executed by a processor perform a method, the method comprising:
creating, by a modeling module, a sector geometry representative of a coverage area of an antenna in a wireless network, based on a tower data of the wireless network and first operational data from the wireless network;
creating, by the modeling module, a geospatial model of a geospatial feature for an area associated with the wireless network; and
generating, by the modeling module, one or more range bands, each bound by a first distance and a second distance based on the first operational data;
estimating, by a location module, a location of a mobile device based on the sector geometry of the antenna, the geospatial model of the geospatial feature and the one or more range bands of the antenna.

2. The method of claim 1, further comprising:
extracting, by a parsing module, a signaling record of the mobile device from second operational data obtained from the wireless network;
identifying, based on the signaling record, at least one of the antenna and a non-reference antenna servicing the mobile device; and
determining, based on the signaling record, the mobile device is in a coverage area of the antenna.

3. The method of claim 1, further comprising:
generating, by the modeling module, the one or more range bands of the antenna based on round trip delay values obtained from the first operational data, and
determining, by the modeling module, a dimension of the sector geometry representative of the maximum effective coverage area of the antenna based on the round trip delay values obtained from the first operational data.

4. The method of claim 1, further comprising:
determining, by the modeling module, a geographic location of the antenna based on the tower data, and
generating, by the modeling module, a polygon bounding the geospatial feature.

5. The method of claim 2, further comprising:
selecting, by the location module, based on round trip delay value associated with the antenna, a range band from the one or more of range bands of the antenna to estimate the location of the mobile device associated with the antenna,
wherein the round trip delay value associated with the antenna is obtained from the signaling record.

6. The method of claim 5, further comprising:
determining, by the location module, a region that is common to an area encompassed by the sector geometry of the antenna, an area encompassed by the selected range band of the antenna and an area associated with the polygon bounding the geospatial feature,
calculating, by the location module, a weighted average center of the common region; and
setting, by the location module, the weighted average center of the common region as the location of the mobile device.

7. The method of claim 5, further comprising:
determining, by the location module, the region that is common to the area encompassed by the sector geometry of the antenna, the area encompassed by the selected range band of the antenna, the area associated with the polygon bounding the geospatial feature, and at least one of
an area encompassed by a sector geometry of the non-reference antenna, and
an area encompassed by a selected range band of the non-reference antenna, the range band of the non-reference antenna is selected based on round trip delay value associated with the non-reference antenna, wherein the round trip delay value of the non-reference antenna is obtained from the signaling record, and
grading, by the location module, an accuracy of the estimated location.

8. A positioning determination engine, comprising:
a modeling module configured to:
create, for at least one antenna of one or more antennas in a wireless network, a sector geometry representative of a coverage area of the at least one antenna based on a tower data of the wireless network and first operational data from the wireless network;
create a geospatial model of a geospatial feature for an area associated with the wireless network; and
generate, for the at least one antenna, one or more range bands, each bound by a first distance and a second distance based on the first operational data;
a location module configured to estimate a location of a mobile device communicatively associated with an antenna of the one or more antennas in the wireless network based on the sector geometry of the antenna, the geospatial model of the geospatial feature, the one or more range bands of the antenna and second operational data.

9. The position determination engine of claim 8, further comprising:
a parsing module configured to:
extract a signaling record of the mobile device from the second operational data obtained from the wireless network; and
identify, based on the signaling record, at least one of the antenna communicatively associated with the mobile device and a non-reference antenna of the one or more antennas associated with the mobile device

10. The positioning determination engine of claim 8:
wherein the one or more range bands are generated based on round trip delay values obtained from the first operational data, and
wherein a dimension of the sector geometry representative of the maximum effective coverage area of the antenna is determined based on the round trip delay values obtained from the first operational data.

11. The positioning determination engine of claim 8:
wherein the modeling module to determine a geographic location of each antenna of the one or more antennas in the wireless network based on the tower data, and
wherein the modeling module to generate a polygon bounding the geospatial feature.

12. The positioning determination engine of claim 9:
wherein the location module is configured to select, based on round trip delay value associated with the antenna, a range band from the one or more of range bands of the antenna to estimate the location of the mobile device associated with the antenna, and
wherein the round trip delay value associated with the antenna is obtained from the signaling record.

13. The positioning determination engine of claim 12:
wherein the location module is configured to determine a region that is common to an area encompassed by the sector geometry of the antenna, an area encompassed by the selected range band of the antenna and an area associated with the polygon bounding the geospatial feature,
wherein the location module is configured to calculate a weighted average center of the common region; and
wherein the location module is configured to set the weighted average center of the common region as the location of the mobile device.

14. The positioning determination engine of claim 12:
wherein the location module is configured to determine a region that is common to the area encompassed by the sector geometry of the antenna, the area encompassed by the selected range band of the antenna, the area associated with the polygon bounding the geospatial feature, and at least one of
an area encompassed by a sector geometry of the non-reference antenna, and
an area encompassed by a selected range band of the non-reference antenna, the range band of the non-reference antenna is selected based on round trip delay value associated with the non-reference antenna, wherein the round trip delay value of the non-reference antenna is obtained from the signaling record, and
wherein the location module is configured to grade an accuracy of the estimated location.

15. A computer program product tangibly embodied in a non-transitory storage medium and comprising instructions that when executed by a processor perform a method, the method comprising:
creating, by a modeling module, for each antenna of one or more antennas in a wireless network, a sector geometry representative of a coverage area of each antenna based on a tower data of the wireless network and first operational data from the wireless network;
creating, by the modeling module, a geospatial model of a geospatial feature for an area associated with the wireless network; and
generating, by the modeling module, for each antenna, one or more range bands, each bound by a first distance and a second distance based on the first operational data;
estimating, by a location module, a location of a mobile device communicatively associated with an antenna of the one or more antennas in the wireless network based on the sector geometry of the antenna, the geospatial model of the geospatial feature, and the one or more range bands of the antenna.

16. The method of claim 15, further comprising:
extracting, by the parsing module, signaling data from second operational data, wherein the second operation data is obtained from the wireless network; and
based on the signaling record, identifying, by the parsing module, at least one of the antenna communicatively associated with the mobile device and a non-reference antenna of the one or more antennas associated with the mobile device.

17. The method of claim 15:
generating, by the modeling module, a polygon that bounds the geospatial feature;
determining, by the modeling module, for each range band of each antenna, a ring geometry representative of a portion of the range band that intersects an area encompassed by the sector geometry of respective antenna; and
determining, by the modeling module, for each ring geometry, a ring road geometry representative of a portion of the polygon bounding the geospatial feature that intersects the ring geometry.

18. The method of claim 17:
creating, by the modeling module, a cell sector database comprising data representative of at least one of:
the sector geometry of each antenna,
the one or more range bands of each antenna,
the ring geometry of each range band of each antenna, and
the ring road geometry of each ring geometry.

19. The method of claim 16, further comprising:
based on round trip delay value associated with the antenna, selecting a range band from the one or more range bands of the antenna to estimate the location of the mobile device associated with the antenna, the round trip delay value associated with the antenna is obtained from the signaling record; and
based on round trip delay value associated with the non-reference antenna, selecting a range band from the one or more range bands of the non-reference antenna, the round trip delay value associated with the non-reference antenna is obtained from the signaling record.

20. The method of claim 18, further comprising: determining the location of the mobile device based on the cell sector database and the signaling record.

21. The method of claim 19, further comprising:
determining, by an intersection module, whether the selected range band of the antenna has a ring road geometry;
calculating a weighted average center of the ring road geometry; and
setting the weighted average center of the ring road geometry as the location of the mobile device.

22. The method of claim 15, further comprising: determining the location of the mobile device based on the antenna and the at least one non-reference antenna to increase an accuracy of the determined location.

23. The method of claim 22:
determining, by the intersection module, whether the selected range band of the non-reference antenna has a ring road geometry;
determining, by the intersection module, whether an area encompassing the ring road geometry of the antenna and an area encompassing the ring road geometry of the non-reference antenna overlap; and
calculating a weighted average center of the overlapping region.

24. The method of claim 22, further comprising:
determining, by the intersection module, whether the selected range band of the non-reference antenna has a ring geometry;
determining, by the intersection module, a region common to the area encompassed by sector geometry of the antenna, the area encompassed by the ring road geometry of the antenna and at least one of:
the area encompassed by ring road geometry of the non-reference antenna,
an area encompassed by the ring geometry of the non-reference antenna, and
an area encompassed by the range band of the non-reference antenna, and calculating a weighted average center of the common region.

25. A system, comprising:
a position determination engine, the position determination engine comprising:
a modeling module configured to:
create, for each antenna of one or more antennas in a wireless network, a sector geometry representative of a coverage area of each antenna based on a tower data of the wireless network and historical signaling data from the wireless network;
create a geospatial model of a geospatial feature for an area associated with the wireless network; and
generate, for each antenna, one or more range bands, each bound by a first distance and a second distance from the antenna based on the historical signaling data;
a location module configured to estimate a location of a mobile device in the wireless network based on:
the sector geometry of at least one antenna of the one or more antennas in the wireless network,
the geospatial model of the geospatial feature,
the one or more range bands of the at least one antenna, and
real-time signaling data obtained from the wireless network.

26. The system of claim 25, wherein the position determination engine further comprises:
a parsing module configured to:
extract a signaling record of the mobile device from the real-time signaling data; and
uniquely identify, based on the signaling record, at least one of a reference antenna and a non-reference antenna serving the mobile device in the wireless network, the reference antenna and the non-reference antenna associated with the one or more antennas in the wireless network.

27. The system of claim 25:
wherein the one or more range bands are generated based on round trip delay values obtained from the historical signaling data,
wherein a dimension of the sector geometry representative of the maximum effective coverage area of the antenna is determined based on the round trip delay values obtained from the historical signaling data, and
wherein the modeling module is configured to generate a polygon bounding the geospatial feature.

28. The system of claim 25:
wherein the location module is configured to select, based on round trip delay value associated with the reference antenna, a range band from the one or more of range bands of the reference antenna to estimate the location of the mobile device associated with the antenna, and
wherein the round trip delay value associated with the reference antenna is obtained from the signaling record.

29. The system of claim 28:
wherein the location module is configured to determine a region that is common to an area encompassed by the sector geometry of the reference antenna, an area encompassed by the selected range band of the reference antenna and an area associated with the polygon bounding the geospatial feature,
wherein the location module is configured to calculate a weighted average center of the common region; and
wherein the location module is configured to set the weighted average center of the common region as the location of the mobile device.

30. The system of claim 28:
wherein the location module is configured to determine a region that is common to the area encompassed by the sector geometry of the reference antenna, the area encompassed by the selected range band of the reference antenna, the area associated with the polygon bounding the geospatial feature, and at least one of
an area encompassed by a sector geometry of the non-reference antenna, and
an area encompassed by a selected range band of the non-reference antenna, the range band of the non-reference antenna is selected based on round trip delay value associated with the non-reference antenna, wherein the round trip delay value of the non-reference antenna is obtained from the signaling record, and
wherein the location module is configured to grade an accuracy of the estimated location.

31. A positioning determination engine, comprising:
a modeling module configured to:
create, for each antenna of one or more antennas in the wireless network, a sector geometry representative of a coverage area of each antenna based on a tower data of the wireless network and first operational data from the wireless network;
create a geospatial model of a geospatial feature for an area associated with the wireless network; and
a location module configured to estimate a location of a mobile device communicatively associated with an antenna of the one or more antennas in the wireless network based on:
the sector geometry of the antenna,
the geospatial model of the geospatial feature, and
a range band of the antenna.

32. The position determination engine of claim 31, further comprising:
a parsing module configured to:
extract a signaling record of the mobile device from second operational data obtained from the wireless network;
identify, based on the signaling record, at least one of the antenna communicatively associated with the mobile device and a non-reference antenna of the one or more antennas associated with the mobile device;
determining, based on the signaling record, at least one of a round trip delay (RTD) value associated with the antenna and an RTD value associated with the non-reference antenna.

33. The positioning determination engine of claim 31:
wherein a dimension of the sector geometry representative of the maximum effective coverage area of the antenna is determined based on the round trip delay values obtained from the first operational data,
wherein the modeling module to determine a geographic location of each antenna of the one or more antennas in the wireless network based on the tower data, and
wherein the modeling module to generate a polygon bounding the geospatial feature.

34. The positioning determination engine of claim 32:
wherein the location module is configured to create, based on the RTD value associated with the antenna, the range band of the antenna to estimate the location of the mobile device associated with the antenna, and
wherein the range band of the antenna is bound by a first distance and a second distance that is calculated based on the RTD value associated with the antenna.

35. The positioning determination engine of claim 31:
wherein the location module is configured to determine a region that is common to an area encompassed by the sector geometry of the antenna, an area encompassed by the range band of the antenna and an area associated with the polygon bounding the geospatial feature,
wherein the location module is configured to calculate a weighted average center of the common region; and
wherein the location module is configured to set the weighted average center of the common region as the location of the mobile device.

36. The positioning determination engine of claim 31:
wherein the location module is configured to determine a region that is common to the area encompassed by the sector geometry of the antenna, the area encompassed by the range band of the antenna, the area associated with the polygon bounding the geospatial feature, and at least one of
an area encompassed by a sector geometry of the non-reference antenna, and
an area encompassed by a range band of the non-reference antenna, the range band of the non-reference antenna is created based on RTD value associated with the non-reference antenna, and
wherein the location module is configured to grade an accuracy of the estimated location.

37. A system comprising:
a position determination engine, the position determination engine comprising:
a modeling module configured to:
create, for at least one antenna of one or more antennas in a wireless network, a sector geometry representative of a coverage area of the at least one antenna based on a tower data of the wireless network and historical signaling data from the wireless network;
create a geospatial model of a geospatial feature for an area associated with the wireless network; and
generate, for the at least one antenna, one or more range bands, each bound by a first distance and a second distance from the antenna based on the historical signaling data;
a location module configured to estimate a location of a mobile device in the wireless network based on:
the sector geometry of the at least one antenna of one or more antennas in the wireless network,
the geospatial model of the geospatial feature,
the one or more range bands of the at least one antenna, and
real-time signaling data obtained from the wireless network.

38. The system of claim 25, wherein the position determination engine further comprises:
a parsing module configured to:
extract a signaling record of the mobile device from the real-time signaling data; and
identify, based on the signaling record, one or more antennas serving the mobile device.

39. The system of claim 38:
wherein the parser module is configured to identify a reference antenna from the one or more antennas serving the mobile device by sorting the one or more antennas based on round trip delay values associated with the one or more antennas, and
wherein the reference antenna is the antenna with the least round trip delay value.

40. The system of claim 38, wherein the parser module is configured to identify a reference antenna from the one or more antennas serving the mobile device based on a reference identifier field in the signaling record.

41. The system of claim 40:
wherein the one or more antennas serving the mobile device comprises a plurality non-reference antennas,
wherein the plurality of non-reference antennas are sorted based on at least one of round trip delay values and signal strength values associated with the one or more non-reference antennas.

42. The system of claim 37:
wherein the one or more range bands are generated based on round trip delay values obtained from the historical signaling data,
wherein a dimension of the sector geometry representative of the maximum effective coverage area of the antenna is determined based on the round trip delay values obtained from the historical signaling data, and
wherein the modeling module is configured to generate a polygon bounding the geospatial feature.

43. The system of claim 37:
wherein the location module is configured to select, based on round trip delay value associated with an antenna, a range band from the one or more of range bands of the antenna to estimate the location of the mobile device, and
wherein the round trip delay value associated with the antenna is obtained from the signaling record.

44. The system of claim 37:
wherein the location module is configured to determine a region that is common to an area encompassed by the sector geometry of the reference antenna, an area encompassed by the selected range band of the reference antenna and an area associated with the polygon bounding the geospatial feature,
wherein the location module is configured to calculate a weighted average center of the common region; and
wherein the location module is configured to set the weighted average center of the common region as the location of the mobile device.

45. The system of claim 37:
wherein the location module is configured to determine a region that is common to the area encompassed by the sector geometry of the reference antenna and at least one of:
the area encompassed by the selected range band of the reference antenna,
the area associated with the polygon bounding the geospatial feature,
an area encompassed by a sector geometry of at least one of the plurality of the non-reference antennas, and
an area encompassed by a selected range band of at least one of the plurality of the non-reference antennas, the range band of a non-reference antenna is selected based on round trip delay value associated with the non-reference antenna, wherein the round trip delay value of the non-reference antenna is obtained from the signaling record,
wherein the location module is configured to calculate a weighted average center of the common region,
wherein the location module is configured to set the weighted average center of the common region as the location of the mobile device, and
wherein the location module is configured to grade an accuracy of the estimated location.
